(19) United States
(12) Patent Application Publication
(10) Pub. No.: US 2011/0039610 A1
(43) Pub. Date: Feb. 17, 2011

(54) GAMING APPARATUS AND METHODS FOR PROVIDING ONE OR MORE GAMING SESSIONS

(75) Inventors: Anthony J. Baerlocher, Reno, NV (US); Daniel J. DeWaal, Las Vegas, NV (US); David H. Muir, Wamesbay (AU)

Correspondence Address: K&L Gates LLP, P.O. Box 1135, CHICAGO, IL, 60690, US

(73) Assignee: IGT, Reno, NV (US)

(21) Appl. No.: 12/539,932

(22) Filed: Aug. 12, 2009

(51) Int. Cl. A63F 9/24; A63F 13/00

(52) U.S. Cl. 463/12; 463/30; 463/43

(57) ABSTRACT

A gaming system tracks the outcomes of a plurality of plays of a primary game. For example, for each of a plurality of blackjack hands, the gaming system tracks the sum of the cards of that hand. The plurality of tracked primary game outcomes form a gaming session. During the gaming session, the gaming system aggregates (such as by adding) the outcomes of the plurality of plays of the primary game, and determines a corresponding gaming session outcome. The gaming system provides a primary award is provided for any winning primary game outcomes, and a secondary award based on the gaming session outcome. In one embodiment, the gaming system tracks the outcomes of a plurality of simultaneous gaming sessions. In one embodiment, the gaming system enables a plurality of players to participate in at least one of the gaming sessions.

### COPYRIGHT NOTICE

A portion of the disclosure of this patent document contains material which is subject to copyright protection. The copyright owner has no objection to the photocopy reproduction of the patent document or the patent disclosure in exactly the form it appears in the Patent and Trademark Office patent file or records, but otherwise reserves all copyright rights whatsoever.

### BACKGROUND

Gaming machines which provide players awards in primary or base games are well known. Gaming machines generally require the player to place or make a wager to activate the primary or base game. In many of these gaming machines, any award is based on the player obtaining a winning symbol or symbol combination and on the amount of the wager (e.g., the higher the wager, the higher the award). In such known gaming machines, the amount of the wager made on the base game by the player may vary.

Gaming machines which provide secondary or bonus games are also known. Such secondary or bonus games usually provide an additional award, such as a bonus award, to the player. Secondary or bonus games usually do not require an additional wager by the player to be activated. Instead, secondary or bonus games are generally activated or triggered upon an occurrence of a designated triggering event in the primary or base game. When a secondary or bonus game is triggered, the gaming machine generally indicates this triggering to the player through one or more visual and/or audio output devices, such as one or more reels, lights, speakers, video screens, etc. Part of the enjoyment and excitement of playing certain gaming machines is the possibility and occurrence or triggering of the secondary or bonus game (even before the player knows how much the bonus award will be).

Table-based games are also well known. Such table-based games typically enable a plurality of players to each sit at a table, wager on plays of the game, and receive any awards based on game outcomes. Frequently, the outcome of the table-based game is determined based on a plurality of physical gaming elements or components, such as cards, which are dealt for the play of the game. Other table-based games result in awards provided to the players based on random outcomes determined by physical gaming elements or components, such as based on rolls of one or more dice, based on the spin of a wheel such as a roulette wheel, or based on some other random or pseudo-random game outcome.

Certain popular table-based games are blackjack games in which players are initially dealt two cards in exchange for a wager on the play of the game. In such games, players are generally provided a choice of whether to accept an additional card (i.e., to hit) or to not accept an additional card and instead to play the game using the cards then on the table (i.e., to stand). If the player at any point is dealt a series of cards which have a total face value exceeding twenty-one, the player loses his or her wager (i.e., busts) and must wait until the next hand to wager again. If the sum of the cards in the player's hand does not exceed a value of twenty-one, the dealer compares the value of the sum of cards in the player's hand to the value of the sum of the cards in the dealer's hand. The player wins an award if the value of the sum of the cards in the player's hand exceeds the value of the sum of the cards in the dealer's hand. Thus, players of table-based blackjack games must weight the possibility of receiving a card and exceeding a total value of twenty-one against the possibility of not receiving an additional card and instead holding a hand with cards having values whose sum is below the value of the sum of the cards held by the dealer.

Other known table-based games, such as Baccarat, Sic Bo, craps, and poker and its variants, provide a player with a game award for a single, discrete play of the game. Thus, in such games, when the play of the game is over, the next play of the game begins and any award received for the next play of the game is determined independent of the award received for the first play of the game.

There is a need to increase the excitement and entertainment for players of table-based games by providing the players with additional considerations and decisions to be made during plays of those games and by providing additional awards based on these considerations and decisions. There is a further need to provide games including these additional considerations and decisions without requiring players to re-learn the rules of the games described above.

### SUMMARY

The present disclosure relates generally to gaming systems and methods for providing a game in which, in addition to any primary game awards associated with the individual outcomes of each of a plurality of plays of a primary game, the gaming system also determines whether to provide any secondary award based on an aggregation of the outcomes of the plurality of plays of the primary game. More particularly, the present disclosure relates to a gaming system and method which track the outcomes of a plurality of plays of a primary game that form a gaming session, and which determine a session score based on the plurality of plays of the primary game that form the gaming session. The contribution to the session score of each of the plurality of plays of the primary game which form the gaming session may be a score that is contrary to or different from the score used in an evaluation of that play of the primary game. In various embodiments, the gaming system and method determine any session award based on the session score at the end of the gaming session. In one embodiment, the gaming system simultaneously tracks a plurality of session scores for a plurality of overlapping or partially overlapping gaming sessions, wherein at least one of the gaming sessions begins and/or ends for a different play of the primary game than at least one of the other gaming sessions.

In one embodiment, the gaming system disclosed herein enables a player to wager on a play of a primary game, wherein the play of the primary game results in a quantifiable primary game outcome. In this embodiment, the gaming system also enables the player to simultaneously participate in a gaming session spanning or including a plurality of plays of the primary game. During the gaming session, the gaming system determines a quantity representing each of the plurality of spanned plays of the primary game and determines an aggregate value or session score for the gaming session based on the outcome of each such play of the primary game. For example, for each play of the primary game, the gaming system adds a value representative of the primary game outcome to the session score. In one embodiment, the session score for a gaming session is dependent upon the odds of generating one or more outcomes of the primary game spanned by or included in the session. Thus, the odds or average expected paybacks associated with a primary game determine or dictate the expected session scores for one or more gaming sessions. In one embodiment, at the end of the gaming session, the gaming system determines a session award (if any) based on the session score for the gaming session. For example, the gaming system determines the session award by comparing the session score at the end of a gaming session to a plurality of tiers of a payout table (at designated times or points in time), wherein each tier of the payout table is associated with a range of session scores and a session award.

In various embodiments, the gaming system enables the player to participate in one or more gaming sessions during a plurality of plays of the primary game. In one such embodiment, the gaming system and method enable a player to wager on a play of a primary game, and also enable the player to make an appropriate side-wager to fund a gaming session. In another such embodiment, the gaming system enables a player to participate in a gaming session without placing an additional wager on the gaming session. In this embodiment, the gaming session is funded via the average expected payback percentage (e.g., as defined by an appropriate paytable) of the underlying primary game. That is, a portion of the player's wagers on the plays of the primary game funds one or more session awards for one or more gaming sessions, as further described in detail below. In one embodiment, the gaming system funds any session awards based in part on a side-wager made on a gaming session, and in part on a wager on a play of the underlying primary game. In another embodiment, the gaming session is funded via one or more promotions, such that a player is provided access to a gaming session (and potentially to a corresponding session award) without any additional wager on the gaming session.

In one embodiment, the gaming system determines whether a player's decisions during a plurality of plays of a primary game are optimal or sub-optimal with respect to either the primary game or a then-active gaming session. In one embodiment, optimal play with respect to the primary game maximizes an average expected payback percentage for the primary game. In this embodiment, optimal play with respect to a gaming session results in an optimal average expected session score for the gaming session.

Thus, in one embodiment, the gaming system and methods disclosed herein enable a player to participate in a primary game, such as a conventional blackjack game, and to simultaneously participate in one or more gaming sessions. In, this embodiment, the gaming system and methods disclosed enable the player to make one or more decisions for one or more plays of the primary game, which decisions impact not only the current play of the primary game, but also the session score of any session which spans or includes the current play of the primary game. It should be appreciated that in certain embodiments, the primary game and game are configured such that one or more decisions which can be made during the plays of the primary game are optimal with respect to both the plays of the primary game and with respect to the session score. Likewise, in certain embodiments, certain decisions are sub-optimal with respect to both the plays of the primary game and with respect to the session score. In such embodiments, one or more decisions made during the one or more plays of the primary game are optimal with respect to one or more plays of the primary game, but are sub-optimal with respect to the session score, and one or more decisions made during the one or more plays of the primary game are sub-optimal with respect to one or more plays of the primary game, but are optimal with respect to the session score.

In one embodiment, the gaming system and method disclosed herein track one or more gaming sessions spanning a plurality of plays of a table game using physical gaming elements or components, such as a blackjack game using physical playing cards and wagering chips. For a play or hand of the blackjack game, the gaming system and method track the values of the cards initially dealt to the player as well as the values of any additional cards dealt to the player during the hand (e.g., cards dealt if the player hits, splits, or doubles down). In one embodiment, for each hand of blackjack, the gaming system and method determine and store a sum of the face values of each of the cards in each player's hand, such as by tracking the cards as they are dealt to the player utilizing a card tracking device, and provides the player an appropriate award based on standard blackjack rules.

In one embodiment, the gaming system and method also tracks the sums of the values of the cards in each player's hand over the course of a gaming session spanning a plurality of plays or hands of the primary blackjack game. This aggregation of the values of the cards dealt to a player during the gaming session is referred to herein as the session score. In one embodiment, the gaming system does not increase the session score if the sum of the values in the player's blackjack hand exceeded twenty-one (i.e., if the player busted). For example, if for three consecutive plays of blackjack, the player received cards with total values of seventeen, twenty-three, and twenty, respectively, the gaming system determines a session score of thirty-seven (i.e., because the player busted on the second hand, the gaming system does not increment the session score for that hand). It should be appreciated that in one embodiment a session score represents an aggregate score for a plurality of otherwise independent plays of the primary game, and is determined in parallel with or simultaneously with the plays of the primary game.

In one embodiment, at the conclusion of a gaming session, the gaming system determines whether to provide a session award to a player based on the accumulated session score. In one such embodiment, in general, the smaller the difference between a player's accumulated session score and an optimal session score, the larger the session award. For example, in a blackjack game wherein a gaming session spans ten hands of blackjack, an optimal session score is two-hundred-ten points (i.e., the maximum possible sum of values of each hand is twenty-one points, thus, the maximum possible session score is twenty-one points times ten hands or two-hundred-ten points). Generally, in this example embodiment, the closer a player's session score is to two-hundred-ten points, the larger the player's session award.

In one embodiment wherein the gaming system determines one or more session awards based on an application of one or more paytables, sub-optimal play with respect to the primary game reduces the average expected payout of the primary game. That is, sub-optimal play results in an average session score which, when applied to one or more paytables, generates an award with a relatively low average expected payout value. In this embodiment, the relatively low average expected payout value provides that a relatively lower portion of each wager on a play of the game is returned to the players as session awards. In another embodiment wherein the gaming system provides one or more session awards based on a value accumulated in one or more pools, sub-optimal play, with respect to the primary game funds any session awards provided to players for one or more gaming sessions by causing a larger portion of each wager on each play of the primary game to be allocated to a pool, the pool usable to fund any session awards provided to a player. Accordingly, sub-optimal play of the game in this embodiment results in a relatively greater pool of potential awards and thus also results in greater session awards for plays of the disclosed session game.

In one embodiment, the gaming system determines the session award by comparing the player's session score with a plurality of tiers of session scores, wherein the tiers are associated with awards based on the optimal session score. If the player's session score falls within one of the tiers, the gaming system provides a session award associated with that tier. For example, in a three-tiered arrangement, the gaming system provides the player a lowest session award if the player's session score falls within a range associated with a first tier, a middle session award if the player's session score falls within a range associated with a second tier, and a highest session score if the player's session score falls within a range associated with a third tier. In one embodiment, the highest available session awards are relatively large compared to awards available winnable for plays of the primary game.

In one embodiment, the gaming system disclosed herein tracks the session scores of a plurality of simultaneous different gaming sessions for a plurality of plays of the primary game. For example, for a first play of the primary game, the gaming system begins tracking a first session score. For a subsequent second play of the primary game, the gaming system increases the first session score and begins tracking a separate, second session score. For a plurality of further subsequent plays of the primary game, both the first and second session scores are increased. Eventually, the first session ends (e.g., after the tenth play of the primary game), and the gaming system determines which (if any) of the tiers the first session score falls within. Thereafter, the second session ends (e.g., after the eleventh play of the primary game), and the gaming system determines which (if any) of the tiers the second session score falls within. The gaming system provides a session award if either of the session scores falls within one of the appropriate tiers of session scores associated with a session award. In another embodiment, the gaming system tracks a plurality of simultaneous gaming sessions which each begin and end for the same plays of the primary game. In one such embodiment, the gaming system determines a first award for a first gaming session based on a first payout table. In this embodiment, the gaming system determines a second award for a second gaming session based on a second payout table which may be different from the first payout table, wherein the first gaming session and the second gaming session span or include a same plurality of plays of a primary game.

It should be appreciated that because the session enabled by the disclosed gaming system is tracked simultaneously with a plurality of plays of the primary game, the disclosed gaming system may alter the player's strategy decisions from those made during a standard game of blackjack. While during a standard hand of blackjack a player may decide to accept another card based on the combination of the player's cards and the dealer's card despite a risk of exceeding a total hand value of twenty-one, during a hand of blackjack in which the session score is being tabulated by the disclosed gaming system, the player may elect not to accept another card for the same combination of player cards and dealer card. For example, if a player has cards totaling sixteen and the dealer's visible card is a nine, the player may elect not to hit because of a desire to increase his or her session score by sixteen points, despite the risk of losing the hand of blackjack. It should be appreciated that this decision may be made because not taking another card would result in a guaranteed increase in the session score, while taking another card results in the possibility of exceeding a hand value of twenty-one and thus not increasing the session score. On the other hand, the player may elect to hit in an effort to achieve a higher session score despite such a hit resulting in a high risk of exceeding twenty-one for the blackjack hand. For example, if the cards in the player's hand total twelve and the dealer's visible card is a six, the player may elect to hit in an effort to increase his or her session score, despite the relatively higher risk of losing the hand of blackjack.

It should also be appreciated that the gaming system and methods disclosed herein increase player excitement and enjoyment by requiring players to weigh a desire to achieve maximum results during each play of the primary game against a desire to achieve a maximum session score, and thus a maximum possible session award. It should be further appreciated that the gaming system and methods disclosed herein increase player excitement and enjoyment by enabling players to weigh the desirability of winning the relatively smaller primary game awards against the potential to win the potentially larger session awards.

It should be appreciated that while the embodiments discussed herein focus primarily on gaming sessions spanning a plurality of hands of a blackjack game, in various other embodiments, the disclosed gaming system and methods are usable to provide session awards for gaming sessions spanning a plurality of plays of any appropriate primary game, such as Baccarat, Sic Bo, craps, poker, or combinations of these games. It should be further appreciated that the disclosed gaming system is usable to provide session awards for gaming sessions spanning a plurality of plays of either table games, such as table-based blackjack games, or non-table games, such as video blackjack games.

In one embodiment, the gaming system disclosed herein is configured to track a plurality of plays of a primary game (such as a blackjack game) which occur at a physical gaming table. In one embodiment, the gaming system disclosed herein includes a microprocessor-based intelligent table for tracking any cards, chips, and/or other physical gaming elements used during plays of the primary game. In one such embodiment, the intelligent table includes at least one tracking device, such as a microprocessor-based intelligent table utilizing image recognition and/or RFID tracking to track playing cards and/or casino chips. In various embodiments, the intelligent table includes one or more integrated tracking devices, or is retrofitted with one or more tracking devices such that a previously-existing gaming table is usable to track session scores as disclosed.

Additional features and advantages are described in, and will be apparent from, the following Detailed Description and the figures.

### BRIEF DESCRIPTION OF THE FIGURES

FIGS. 1A and 1B are perspective views of example alternative embodiments of the gaming device of the present disclosure.

FIG. 2A is a schematic block diagram of one embodiment of an electronic configuration for one of the gaming devices disclosed herein.

FIG. 2B is a schematic block diagram of one embodiment of a network configuration for a plurality of gaming devices disclosed herein.

FIG. 3 is a perspective view of the gaming table of the present disclosure for tracking physical gaming elements during session gaming.

FIG. 4 is a schematic block diagram of one embodiment of a network configuration for a plurality of gaming tables disclosed herein.

FIG. 5 is a flow chart of an example process for providing a plurality of plays of a primary game and a simultaneous gaming session as disclosed herein.

FIG. 6 is an example diagram of a tiered payout table for determining whether to provide any session award for a gaming session as disclosed herein.

FIG. 7A is a perspective view of an example session score tracking device usable by a player of the gaming system disclosed herein.

FIG. 7B is a perspective view of a display screen for enabling a player to track a plurality of session scores during the session game disclosed herein.

FIG. 8 is a timeline of a plurality of points in time during a plurality of plays of the primary game and a plurality of different gaming sessions as disclosed herein.

FIGS. 9A, 9B, 9C, 9D, and 9E are schematic representations of a gaming table and a plurality corresponding display screen for tracking the gaming sessions active at the plurality of points in time illustrated by the timeline of FIG. 8.

### DETAILED DESCRIPTION

The present disclosure may be implemented in various configurations for gaming machines, gaming devices, or gaming systems, including but not limited to: (1) a dedicated gaming machine, gaming device, or gaming system wherein a plurality of computerized instructions for controlling or tracking any games (which are provided by or with the gaming machine or gaming device) are provided with the gaming machine or gaming device prior to delivery to a gaming establishment; or (2) a changeable gaming machine, gaming device, or gaming system wherein the computerized instructions for controlling or tracking any games (which are provided by or with the gaming machine or gaming device) are downloadable to the gaming machine or gaming device through a data network after the gaming machine or gaming device is in a gaming establishment.

In one embodiment, the computerized instructions for controlling any games are executed by at least one central server, central controller, or remote host. In such a “thin client” embodiment, the central server remotely controls or tracks play of any games (or other suitable interfaces) and the gaming device is utilized to display or detect movement of physical objects in such games (or suitable interfaces) and receive one or more inputs or commands from a player. In another embodiment, the computerized instructions for controlling or tracking any games are communicated from the central server, central controller, or remote host to a gaming device local processor and memory devices. In such a “thick client” embodiment, the gaming device local processor executes the communicated computerized instructions to control or track play of any games (or other suitable interfaces) provided to a player.

In one embodiment, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling or tracking the play of any primary games are communicated from the central server to the gaming device in a thick client configuration and computerized instructions for controlling or tracking any secondary games or bonus functions, including controlling or tracking any active gaming sessions, are executed by a central server in a thin client configuration.

### Gaming System Including Non-Table Gaming Devices

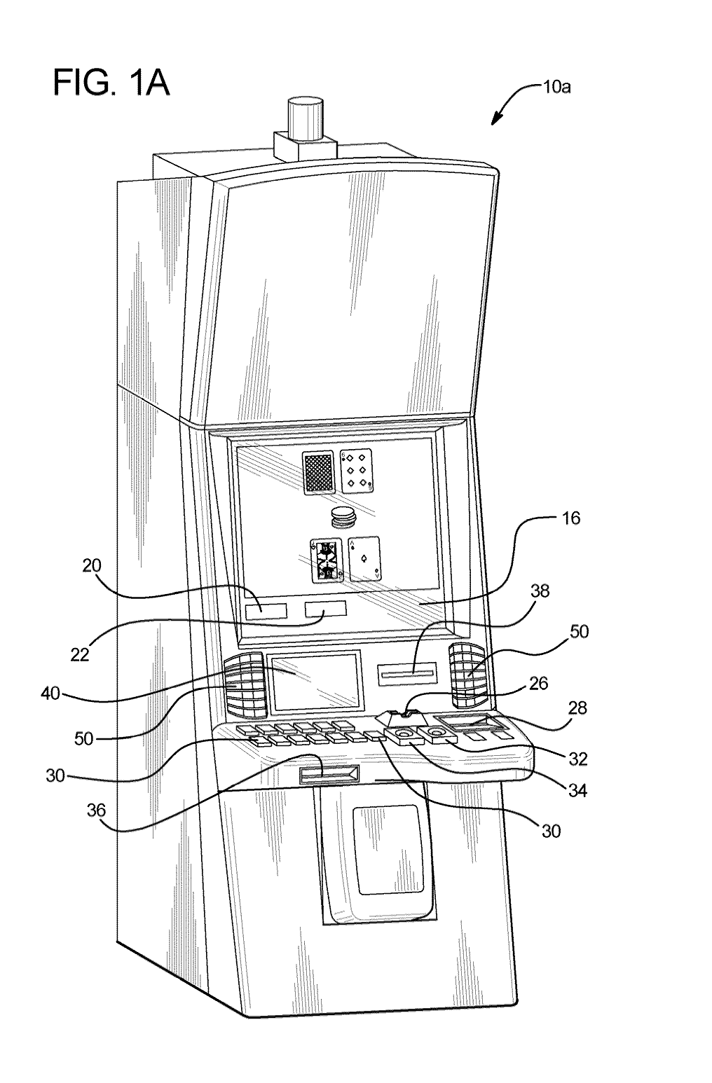

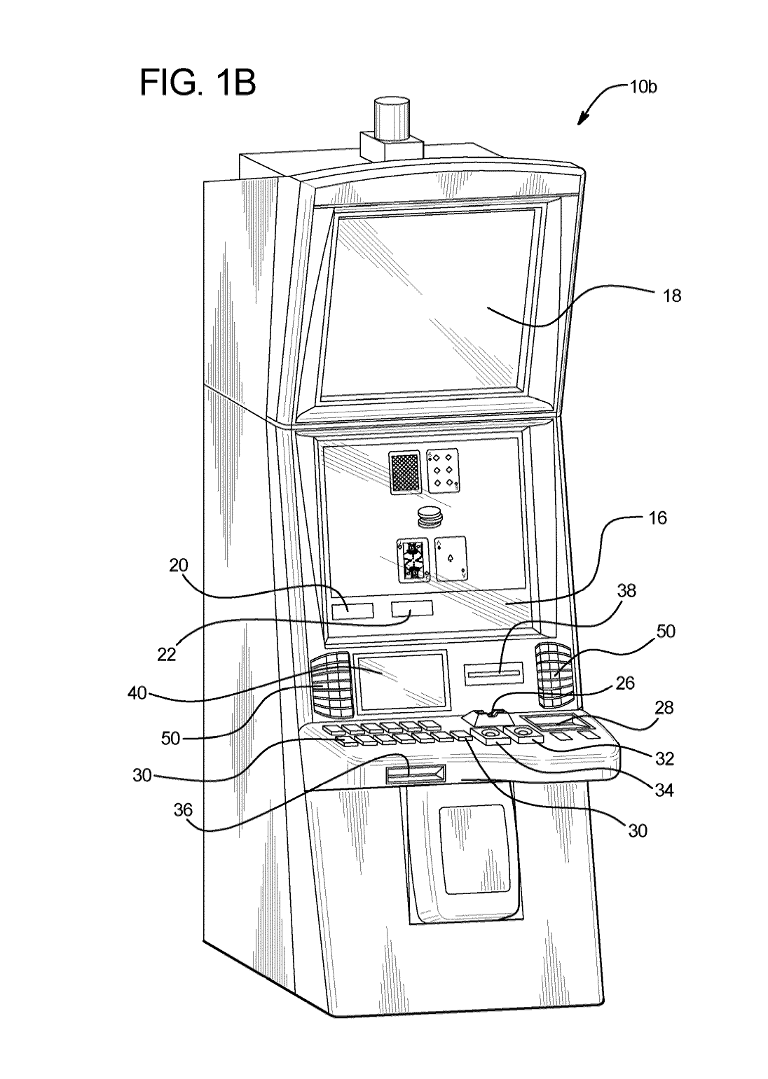

Referring now to the drawings, two example alternative embodiments of a gaming device disclosed herein are illustrated in FIGS. 1A and 1B as gaming device 10a and gaming device 10b, respectively. Gaming device 10a and/or gaming device 10b are generally referred to herein as gaming device 10.

In the embodiments illustrated in FIGS. 1A and 1B, gaming device 10 has a support structure, housing, or cabinet which provides support for a plurality of displays, inputs, controls, and other features of a conventional gaming machine. Gaming device 10 is configured in various embodiments so that a player can operate the gaming device 10 while standing or sitting. The gaming device can be positioned on a base or stand or can be configured as a pub-style table-top game (not shown) which a player can operate preferably while sitting. As illustrated by the different configurations shown in FIGS. 1A and 1B, the gaming device may have varying cabinet and display configurations.

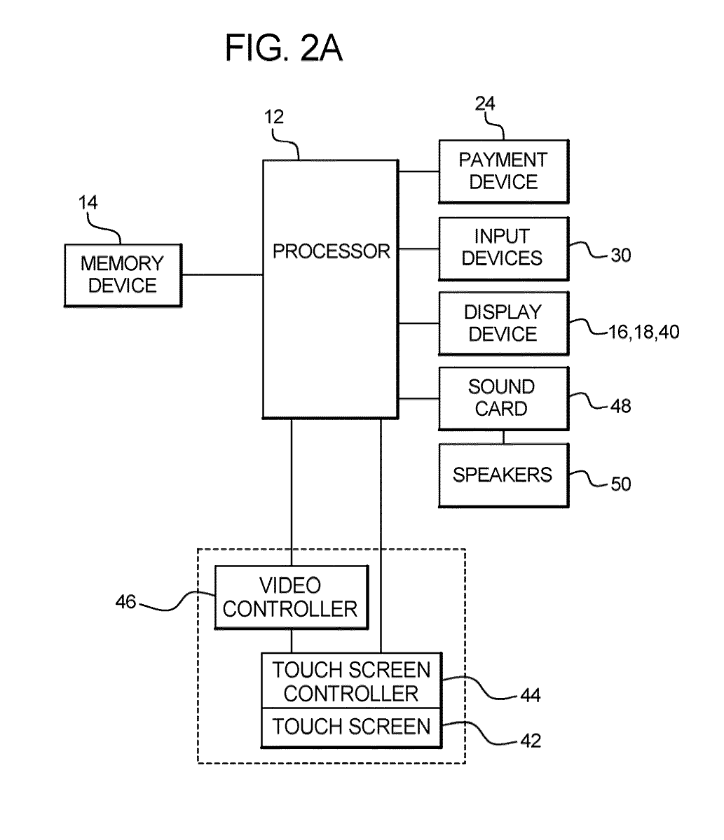

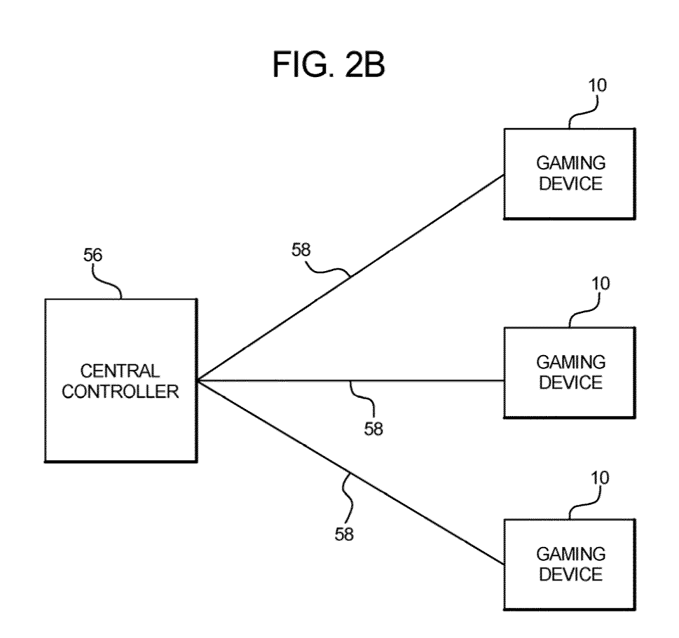

In one embodiment, as illustrated in FIG. 2A, the gaming device preferably includes at least one processor 12, such as a microprocessor, a microcontroller-based platform, a suitable integrated circuit, or one or more application-specific integrated circuits (ASICs). The processor is in communication with or operable to access or exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information, and applicable game rules that relate to the play of one or more games of the gaming device. In one embodiment, the memory device includes random access memory (RAM), which can include non-volatile RAM (NVRAM), magnetic RAM (MRAM), ferroelectric RAM (FeRAM), and other forms of RAM as commonly understood in the gaming industry. In one embodiment, the memory device includes read only memory (ROM). In one embodiment, the memory device includes flash memory and/or EEPROM (electrically erasable programmable read only memory). In various embodiments, any other suitable magnetic, optical, and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD, or USB memory device. In other embodiments, part or all of the program code and/or operating data described above can be downloaded to the memory device through a suitable data network.

In one embodiment, an operator or a player can use such a removable memory device in a desktop computer, a laptop computer, a personal digital assistant (PDA), a portable computing device, or another computerized platform to implement the gaming system of the present disclosure. In one embodiment, the gaming device or gaming machine disclosed herein is operable over a wireless network, for example as part of a wireless gaming system. In this embodiment, the gaming machine may be a hand-held device, a mobile device, or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “computer” or “controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator, or any other suitable randomization process. In one embodiment, each award or game outcome is associated with a probability, and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device flags or removes the provided award or other game outcome from the predetermined set or pool. Once flagged or removed from the set or pool, the specific provided award or other game outcome from that specific pool cannot be provided to the player again. This type of gaming device provides players with all of the available awards or other game outcomes over the course of the play cycle and guarantees the amount of actual wins and losses.

In another embodiment, as discussed below, upon a player initiating game play at the gaming device, the gaming device enrolls in a bingo game. In this embodiment, a bingo server calls the bingo balls or numerals that result in a specific bingo game outcome. The resultant game outcome is communicated to the individual gaming device to be provided to a player. In one embodiment, this bingo outcome is displayed to the player as a bingo game and/or in any form in accordance with the present disclosure.

In one embodiment, as illustrated in FIG. 2A, the gaming device includes one or more display devices controlled by the processor. The display devices are preferably connected to or mounted on the cabinet of the gaming device. The embodiment shown in FIG. 1A includes a central display device 16 which displays a primary game. This display device may also display any suitable secondary game associated with the primary game as well as information relating to the primary or secondary game. The alternative embodiment shown in FIG. 1B includes a central display device 16 and an upper display device 18. The upper display device may display the primary game, any suitable secondary game associated or not associated with the primary game and/or information relating to the primary or secondary game. These display devices may also serve as digital glass operable to advertise games or other aspects of the gaming establishment. As seen in FIGS. 1A and 1B, in one embodiment, the gaming device includes a credit display 20 which displays a player's current number of credits, cash, account balance, or the equivalent. In one embodiment, the gaming device includes a bet display 22 which displays a player's amount wagered. In one embodiment, as described in more detail below, the gaming device includes a player tracking display 40 which displays information regarding a player's play tracking status.

In another embodiment, at least one display device may be a mobile display device, such as a PDA or tablet PC, that enables play of at least a portion of the primary or secondary game at a location remote from the gaming device.

The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In one embodiment, as described in more detail below, the display device includes a touch-screen with an associated touch-screen controller. The display devices may be of any suitable size and configuration, such as a square, a rectangle or an elongated rectangle.

The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, and the like.

In one alternative embodiment, the symbols, images and indicia displayed on or of the display device may be in mechanical form. That is, the display device may include any electromechanical device, such as one or more mechanical objects, such as playing cards, wagering chips, one or more rotatable wheels, reels, or dice, configured to display at least one or a plurality of game or other suitable images, symbols or indicia.

As illustrated in FIG. 2A, in one embodiment, the gaming device includes at least one payment device 24 in communication with the processor. As seen in FIGS. 1A and 1B, a payment device such as a payment acceptor includes a note, ticket or bill acceptor 28 wherein the player inserts paper money, a ticket, or voucher and a coin slot 26 where the player inserts money, coins, or tokens. In other embodiments, payment devices such as readers or validators for credit cards, debit cards or credit slips may accept payment. In one embodiment, a player may insert an identification card into a card reader of the gaming device. In one embodiment, the identification card is a smart card having a programmed microchip, a coded magnetic strip or coded rewritable magnetic strip, wherein the programmed microchip or magnetic strips are coded with a player's identification, credit totals (or related data), and/or other relevant information. In another embodiment, a player may carry a portable device, such as a cell phone, a radio frequency identification tag, or any other suitable wireless device, which communicates a player's identification, credit totals (or related data), and other relevant information to the gaming device. In one embodiment, money may be transferred to a gaming device through electronic funds transfer. When a player funds the gaming device, the processor determines the amount of funds entered and displays the corresponding amount on the credit or other suitable display as described above.

As seen in FIGS. 1A, 1B, and 2A, in one embodiment the gaming device includes at least one and preferably a plurality of input devices 30 in communication with the processor. The input devices can include any suitable device which enables the player to produce an input signal which is received by the processor. In one embodiment, after appropriate funding of the gaming device, the input device is a game activation device, such as a play button 32 or a pull arm (not shown) which is used by the player to start any primary game or sequence of events in the gaming device. The play button can be any suitable play activator such as a bet one button, a max bet button, or a repeat the bet button. In one embodiment, upon appropriate funding, the gaming device begins the game play automatically. In another embodiment, upon the player engaging one of the play buttons, the gaming device automatically activates game play.

In one embodiment, one input device is a bet one button. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash out button 34. The player may push the cash out button and cash out to receive a cash payment or other suitable form of payment corresponding to the number of remaining credits. In one embodiment, when the player cashes out, a payment device, such as a ticket, payment, or note generator 36 prints or otherwise generates a ticket or credit slip to provide to the player. The player receives the ticket or credit slip and may redeem the value associated with the ticket or credit slip via a cashier (or other suitable redemption system). In another embodiment, when the player cashes out, the player receives the coins or tokens in a coin payout tray. It should be appreciated that any suitable payout mechanisms, such as funding to the player's electronically recordable identification card or smart card, may be implemented in accordance with the gaming device disclosed herein.

In one embodiment, as mentioned above and as seen in FIG. 2A, one input device is a touch-screen 42 coupled with a touch-screen controller 44 or some other touch-sensitive display overlay to enable player interaction with the images on the display. The touch-screen and the touch-screen controller are connected to a video controller 46. A player can make decisions and input signals into the gaming device by touching the touch-screen at the appropriate locations. One such input device is a conventional touch-screen button panel.

The gaming device may further include a plurality of communication ports for enabling communication of the processor with external peripherals, such as external video sources, expansion buses, game or other displays, a SCSI port, or a keypad.

In one embodiment, as seen in FIG. 2A, the gaming device includes a sound generating device controlled by one or more sounds cards 48 which function in conjunction with the processor. In one embodiment, the sound generating device includes at least one and preferably a plurality of speakers 50 or other sound generating hardware and/or software for generating sounds, such as by playing music for the primary and/or secondary game or by playing music for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized to provide any appropriate information.

In one embodiment, the gaming machine may include a sensor, such as a camera, in communication with the processor (and possibly controlled by the processor), that is selectively positioned to acquire an image of a player actively using the gaming device and/or the surrounding area of the gaming device. In one embodiment, the camera may be configured to selectively acquire still or moving (e.g., video) images and may be configured to acquire the images in an analog, digital, or other suitable format. The display devices may be configured to display the image acquired by the camera as well as to display the visible manifestation of the game in split screen or picture-in-picture fashion. For example, the camera may acquire an image of the player and the processor may incorporate that image into the primary and/or secondary game as a game image, symbol or indicia.

Gaming device 10 can incorporate any suitable wagering game as the primary or base game. The gaming machine or device may include some or all of the features of conventional gaming machines or devices. The primary or base game may comprise any suitable card game, dice game, reel-type game, cascading or falling symbol game, number game, or other game of chance susceptible to representation in an electronic or electromechanical form, which in one embodiment produces a random outcome based on probability data at the time of or after placement of a wager. That is, different primary wagering games, such as video blackjack games, video poker games, video craps, video keno, video bingo or any other suitable primary or base game may be implemented.

In the embodiment illustrated in FIG. 1A, the gaming device 10a is configured to provide a base or primary game which is a blackjack game wherein the gaming device displays a plurality cards to the player on display device 16. In one embodiment, these cards represent a plurality of player cards and a plurality of dealer cards such as would be dealt in a standard, table-based blackjack game. In this embodiment, the gaming device enables the player to select whether to take additional cards (i.e., to hit), to play with the cards currently held (i.e., to stay), and to perform various other gaming activities available during a standard game of blackjack (e.g., double down, split, surrender, etc.). In one embodiment, the player indicates a desired action by selecting at least one selectable indicia via an input device such as buttons 30 or a touch screen controller. The gaming device then displays the dealer's cards to the player and determines whether the player wins the hand of blackjack based on the relative values of each hand. The player is provided an award based on the relative values of the player's hand, the dealer's hand, and the amount wagered on the hand of blackjack, according to standard blackjack rules.

In one embodiment, a base or primary game is a poker game wherein the gaming device enables the player to play a conventional game of video draw poker and initially deals five cards all face up from a virtual deck of fifty-two cards. In this embodiment, cards are dealt as in a traditional game of cards or in the case of the gaming device, the cards may be randomly selected from a predetermined number of cards. If the player wishes to draw, the player selects the cards to hold via one or more input devices, such as by pressing related hold buttons or via the touch screen. The player then presses the deal button and the unwanted or discarded cards are removed from the display and the gaming machine deals the replacement cards from the remaining cards in the deck. This results in a final five-card hand. The gaming device compares the final five-card hand to a payout table which utilizes conventional poker hand rankings to determine the winning hands. The gaming device provides the player with an award based on a winning hand and the number of credits the player wagered.

In another embodiment, the base or primary game is a multi-hand version of video poker. In this embodiment, the gaming device deals the player at least two hands of cards. In one such embodiment, the cards are the same cards. In one embodiment each hand of cards is associated with its own deck of cards. The player chooses the cards to hold in a primary hand. The held cards in the primary hand are also held in the other hands of cards. The remaining non-held cards are removed from each hand displayed and for each hand replacement cards are randomly dealt into that hand. Since the replacement cards are randomly dealt independently for each hand, the replacement cards for each hand will usually be different. The poker hand rankings are then determined hand by hand against a payout table and awards are provided to the player.

In one embodiment, a base or primary game is a keno game wherein the gaming device displays a plurality of selectable indicia or numbers on at least one of the display devices. In this embodiment, the player selects at least one bit potentially a plurality of the selectable indicia or numbers via an input device such as a touch screen. The gaming device then displays a series of drawn numbers and determine an amount of matches, if any, between the player's selected numbers and the gaming device's drawn numbers. The player is provided an award based on the amount of matches, if any, based on the amount of determined matches and the number of numbers drawn.

In one embodiment, as illustrated in FIG. 2B, one or more of the gaming devices 10 are in communication with each other and/or at least one central controller 56 through a data network or remote communication link 58. In this embodiment, the central server, central controller or remote host is any suitable server or computing device which includes at least one processor and at least one memory or storage device. In different such embodiments, the central server is a progressive controller or a processor of one of the gaming devices in the gaming system. In these embodiments, the processor of each gaming device is designed to transmit and receive events, messages, commands, or any other suitable data or signal between the individual gaming device and the central server. The gaming device processor is operable to execute such communicated events, messages, or commands in conjunction with the operation of the gaming device. Moreover, the processor of the central server is designed to transmit and receive events, messages, commands, or any other suitable data or signal between the central server and each of the individual gaming devices. The central server processor is operable to execute such communicated events, messages, or commands in conjunction with the operation of the central server. It should be appreciated that one, more or each of the functions of the central controller, central server or remote host as disclosed herein may be performed by one or more gaming device processors. It should be further appreciated that one, more or each of the functions of one or more gaming device processors as disclosed herein may be performed by the central controller, central server or remote host.

In one embodiment, the game outcome provided to the player is determined by a central server or controller and provided to the player at the gaming device. In this embodiment, each of a plurality of such gaming devices are in communication with the central server or controller. Upon a player initiating game play at one of the gaming devices, the initiated gaming device communicates a game outcome request to the central server or controller.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a hand of cards dealt in a card game or a roll of one or more dice in a dice game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility, and the like.

In another embodiment, a predetermined game outcome value is determined for each of a plurality of linked or networked gaming devices based on the results of a bingo, keno, or lottery game. In this embodiment, each individual gaming device utilizes one or more bingo, keno, or lottery games to determine the predetermined game outcome value provided to the player for the interactive game played at that gaming device. In one embodiment, the bingo, keno, or lottery game is displayed to the player. In another embodiment, the bingo, keno or lottery game is not displayed to the player, but the results of the bingo, keno, or lottery game determine the predetermined game outcome value for the primary or secondary game.

In the various bingo embodiments, as each gaming device is enrolled in the bingo game, such as upon an appropriate wager or engaging an input device, the enrolled gaming device is provided or associated with a different bingo card. Each bingo card consists of a matrix or array of elements, wherein each element is designated with a separate indicia, such as a number. It should be appreciated that each different bingo card includes a different combination of elements. For example, if four bingo cards are provided to four enrolled gaming devices, the same element may be present on all four of the bingo cards while another element may solely be present on one of the bingo cards.

In operation of these embodiments, upon providing or associating a different bingo card with each of a plurality of enrolled gaming devices, the central controller randomly selects or draws, one at a time, a plurality of the elements. As each element is selected, a determination is made for each gaming device as to whether the selected element is present on the bingo card provided to that enrolled gaming device. This determination can be made by the central controller, the gaming device, a combination of the two, or in any other suitable manner. If the selected element is present on the bingo card provided to that enrolled gaming device, that selected element on the provided bingo card is marked or flagged. This process of selecting elements and marking any selected elements on the provided bingo cards continues until one or more predetermined patterns are marked on one or more of the provided bingo cards. It should be appreciated that in one embodiment, the gaming device requires the player to engage a daub button (not shown) to initiate the process of the gaming device marking or flagging any selected elements.

After one or more predetermined patterns are marked on one or more of the provided bingo cards, a game outcome is determined for each of the enrolled gaming devices based, at least in part, on the selected elements on the provided bingo cards. As described above, the game outcome determined for each gaming device enrolled in the bingo game is utilized by that gaming device to determine the predetermined game outcome provided to the player. For example, a first gaming device to have selected elements marked in a predetermined pattern is provided a first outcome of win $10 which will be provided to a first player regardless of how the first player plays in a first game, and a second gaming device to have selected elements marked in a different predetermined pattern is provided a second outcome of win $2 which will be provided to a second player regardless of how the second player plays a second game. It should be appreciated that as the process of marking selected elements continues until one or more predetermined patterns are marked, this embodiment ensures that at least one bingo card will win the bingo game and thus at least one enrolled gaming device will provide a predetermined winning game outcome to a player. It should be appreciated that other suitable methods for selecting or determining one or more predetermined game outcomes may be employed.

In one example of the above-described embodiment, the predetermined game outcome may be based on a supplemental award in addition to any award provided for winning the bingo game as described above. In this embodiment, if one or more elements are marked in supplemental patterns within a designated number of drawn elements, a supplemental or intermittent award or value associated with the marked supplemental pattern is provided to the player as part of the predetermined game outcome. For example, if the four corners of a bingo card are marked within the first twenty selected elements, a supplemental award of $10 is provided to the player as part of the predetermined game outcome. It should be appreciated that in this embodiment, the player of a gaming device may be provided a supplemental or intermittent award regardless of whether the enrolled gaming device's provided bingo card wins or does not win the bingo game as described above.

In another embodiment, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

In one embodiment, the gaming device disclosed herein is associated with or otherwise integrated with one or more player tracking systems. Player tracking systems enable gaming establishments to recognize the value of customer loyalty through identifying frequent customers and rewarding them for their patronage. In one embodiment, the gaming device and/or player tracking system tracks any player's gaming activity at the gaming device. In one such embodiment, the gaming device includes at least one card reader 38 in communication with the processor. In this embodiment, a player is issued a player identification card which has an encoded player identification number that uniquely identifies the player. When a player inserts their playing tracking card into the card reader to begin a gaming session, the card reader reads the player identification number off the player tracking card to identify the player. The gaming device and/or associated player tracking system timely tracks any suitable information or data relating to the identified player's gaming session. Directly or via the central controller, the gaming device processor communicates such information to the player tracking system. The gaming device and/or associated player tracking system also timely tracks when a player removes their player tracking card when concluding play for that gaming session. In another embodiment, rather than requiring a player to insert a player tracking card, the gaming device utilizes one or more portable devices carried by a player, such as a cell phone, a radio frequency identification tag or any other suitable wireless device to track when a player begins and ends a gaming session. In another embodiment, the gaming device utilizes any suitable biometric technology or ticket technology to track when a player begins and ends a gaming session.

During one or more gaming sessions, the gaming device and/or player tracking system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In one embodiment, such tracked information and/or any suitable feature associated with the player tracking system is displayed on a player tracking display 40. In another embodiment, such tracked information and/or any suitable feature associated with the player tracking system is displayed via one or more service windows (not shown) which are displayed on the central display device and/or the upper display device.

In one embodiment, a plurality of the gaming devices are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system may be substantially identical to the LAN gaming system described above, although the number of gaming devices in each system may vary relative to one another.

In another embodiment, the data network is an internet or intranet. In this embodiment, the operation of the gaming device can be viewed at the gaming device with at least one internet browser. In this embodiment, operation of the gaming device and accumulation of credits may be accomplished with only a connection to the central server or controller (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer or other internet facilitator is available. The expansion in the number of computers and number and speed of internet connections in recent years increases opportunities for players to play from an ever-increasing number of remote sites. It should be appreciated that the enhanced bandwidth of digital wireless communications may render such technology suitable for some or all communications, particularly if such communications are encrypted. Higher data transmission speeds may be useful for enhancing the sophistication and response of the display and interaction with the player.

As mentioned above, in one embodiment, the present disclosure may be employed in a server-based gaming system. In one such embodiment, as described above, one or more gaming devices are in communication with a central server or controller. The central server or controller may be any suitable server or computing device which includes at least one processor and a memory or storage device. In alternative embodiments, the central server is a progressive controller or another gaming machine in the gaming system. In one embodiment, the memory device of the central server stores different game programs and instructions, executable by a gaming device processor, to control the gaming device. Each executable game program represents a different game or type of game which may be played on one or more of the gaming devices in the gaming system. Such different games may include the same or substantially the same game play with different pay tables. In different embodiments, the executable game program is for a primary game, a secondary game or both. In another embodiment, the game program may be executable as a secondary game to be played simultaneous with the play of a primary game (which may be downloaded to or fixed on the gaming device) or vice versa.

In this embodiment, each gaming device at least includes one or more display devices and/or one or more input devices for interaction with a player. A local processor, such as the above-described gaming device processor or a processor of a local server, is operable with the display device(s) and/or the input device(s) of one or more of the gaming devices.

In operation, the central controller is operable to communicate one or more of the stored game programs to at least one local processor. In different embodiments, the stored game programs are communicated or delivered by embedding the communicated game program in a device or a component (e.g., a microchip to be inserted in a gaming device), writing the game program on a disc or other media, or downloading or streaming the game program over a dedicated data network, internet, or a telephone line. After the stored game programs are communicated from the central server, the local processor executes the communicated program to facilitate play of the communicated program by a player through the display device(s) and/or input device(s) of the gaming device. That is, when a game program is communicated to a local processor, the local processor changes the game or type of game played at the gaming device.

In another embodiment, a plurality of gaming devices at one or more gaming sites may be networked to the central server in a progressive configuration, as known in the art, wherein a portion of each wager to initiate a base or primary game is allocated to one or more progressive awards. In one embodiment, a progressive gaming system host site computer is coupled to a plurality of the central servers at a variety of mutually remote gaming sites for providing a multi-site linked progressive automated gaming system. In one embodiment, a progressive gaming system host site computer may serve gaming devices distributed throughout a number of properties at different geographical locations including, for example, different locations within a city or different cities within a state.

In one embodiment, the progressive gaming system host site computer is maintained for the overall operation and control of the progressive gaming system. In this embodiment, a progressive gaming system host site computer oversees the entire progressive gaming system and is the master for computing all progressive jackpots. All participating gaming sites report to, and receive information from, the progressive gaming system host site computer. Each central server computer is responsible for all data communication between the gaming device hardware and software and the progressive gaming system host site computer. In one embodiment, an individual gaming machine may trigger a progressive award win. In another embodiment, a central server (or the progressive gaming system host site computer) determines when a progressive award win is triggered. In another embodiment, an individual gaming machine and a central controller (or progressive gaming system host site computer) work in conjunction with each other to determine when a progressive win is triggered, for example through an individual gaming machine meeting a predetermined requirement established by the central controller.

In one embodiment, a progressive award win is triggered based on one or more game play events, such as a symbol-driven trigger. In other embodiments, the progressive award triggering event or qualifying condition may be achieved by exceeding a certain amount of game play (such as number of games, number of credits, or amount of time), or reaching a specified number of points earned during game play. In another embodiment, a gaming device is randomly or apparently randomly selected to provide a player of that gaming device one or more progressive awards. In one such embodiment, the gaming device does not provide any apparent reasons to the player for winning a progressive award, wherein winning the progressive award is not triggered by an event in or based specifically on any of the plays of any primary game. That is, a player is provided a progressive award without any explanation or alternatively with simple explanations. In another embodiment, a player is provided a progressive award at least partially based on a game triggered or symbol triggered event, such as at least partially based on the play of a primary game.

In one embodiment, one or more of the progressive awards are each funded via a side bet or side wager. In this embodiment, a player must place or wager a side bet to be eligible to win the progressive award associated with the side bet. In one embodiment, the player must place the maximum bet and the side bet to be eligible to win one of the progressive awards. In another embodiment, if the player places or wagers the required side bet, the player may wager at any credit amount during the primary game (i.e., the player need not place the maximum bet and the side bet to be eligible to win one of the progressive awards). In one such embodiment, the greater the player's wager (in addition to the placed side bet), the greater the odds or probability that the player will win one of the progressive awards. It should be appreciated that one or more of the progressive awards may each be funded, at least in part, based on the wagers placed on the primary games of the gaming machines in the gaming system, via a gaming establishment or via any suitable manner.

In another embodiment, one or more of the progressive awards are partially funded via a side-bet or side-wager which the player may make (and which may be tracked via a side-bet meter). In one embodiment, one or more of the progressive awards are funded with only side-bets or side-wagers placed. In another embodiment, one or more of the progressive awards are funded based on player's wagers as described above as well as any side-bets or side-wagers placed.

In one alternative embodiment, a minimum wager level is required for a gaming device to qualify to be selected to obtain one of the progressive awards. In one embodiment, this minimum wager level is the maximum wager level for the primary game in the gaming machine. In another embodiment, no minimum wager level is required for a gaming machine to qualify to be selected to obtain one of the progressive awards.

In another embodiment, a plurality of players at a plurality of linked gaming devices in a gaming system participate in a group gaming environment. In one embodiment, a plurality of players at a plurality of linked gaming devices work in conjunction with one another, such as by playing together as a team or group, to win one or more awards. In one such embodiment, any award won by the group is shared, either equally or based on any suitable criteria, amongst the different players of the group. In another embodiment, a plurality of players at a plurality of linked gaming devices compete against one another for one or more awards. In one such embodiment, a plurality of players at a plurality of linked gaming devices participate in a gaming tournament for one or more awards. In another embodiment, a plurality of players at a plurality of linked gaming devices play for one or more awards wherein an outcome generated by one gaming device affects the outcomes generated by one or more linked gaming devices.

### Gaming System Including Intelligent Gaming Tables

In another embodiment, the gaming system disclosed herein includes at least one central server, central controller, or remote host in communication with or linked to at least one intelligent gaming table or wagering chip tracking system. Each intelligent gaming table enables one or more players to play one or more suitable games by placing one or more wagers utilizing wagering chips such as casino chips. In different embodiments, the intelligent gaming table disclosed herein may be any suitable multi-player station adapted to track wagering chips, playing cards and/or other physical gaming elements used to play a game. Such an intelligent gaming table includes, but is not limited to, a gaming table connected to a processor that is operable to receive and/or send information or data related to: the status of a game or sequence (e.g., amounts wagered, outcomes generated); the status of any player currently playing at the gaming table (e.g., the player's betting history or the player's gaming level in a player tracking system); the status of any wagering position at the gaming table (regardless of identifying a specific player); one or more security features of the gaming system; one or more outcome verification features of the gaming system; one or more payout features of the gaming system; or the status of any other aspect or feature of the player's gaming experience at the gaming table.

In one embodiment, one or more gaming tables of the gaming system each includes at least one processor, such as a microprocessor, a microcontroller-based platform, a suitable integrated circuit, or one or more application-specific integrated circuits (ASICs). In one embodiment, the processor is in signal communication with the central server and/or the player tracking system. In one embodiment, the processor is in signal communication with or is operable to access at least one local data storage device and/or at least one local memory device.

In one embodiment, the local memory device stores information about player gaming activity and/or one or more active sessions in which the player(s) at the table are participating. The local memory may also store, at least in part, other data such as image data, event data, player input data, or information and applicable game rules that relate to the play of the game facilitated by the gaming table. In one embodiment, the local memory device includes at least a portion of random access memory (RAM). In one embodiment, the local memory device includes at least a portion of read only memory (ROM). In one embodiment, the local memory device includes at least a portion of flash memory and/or EEPROM.

In one embodiment, one or more of any intelligent gaming tables utilized in the gaming system are conventional gaming tables wherein the chip identification devices are not directly integrated with, situated on, or embedded in the gaming tables. In this embodiment, one or more chip identification devices which are external to the conventional gaming table are utilized to track each player's wagered chips. In various such embodiments, chip identification devices are located at, above, or below the table. In other such embodiments, the chip identification devices are attached to the gaming table or are positioned adjacent to the gaming table. In another such embodiment, the chip identification devices are embedded within the gaming table. In these embodiments, a gaming establishment providing one or more games using an intelligent gaming table does not have to purchase new gaming tables. Rather, such a gaming establishment can continue using currently existing gaming tables by simply installing any necessary intelligent table technology (i.e., technology needed to track wagering chips, playing cards, or other physical gaming elements) in conjunction with one or more existing gaming tables.

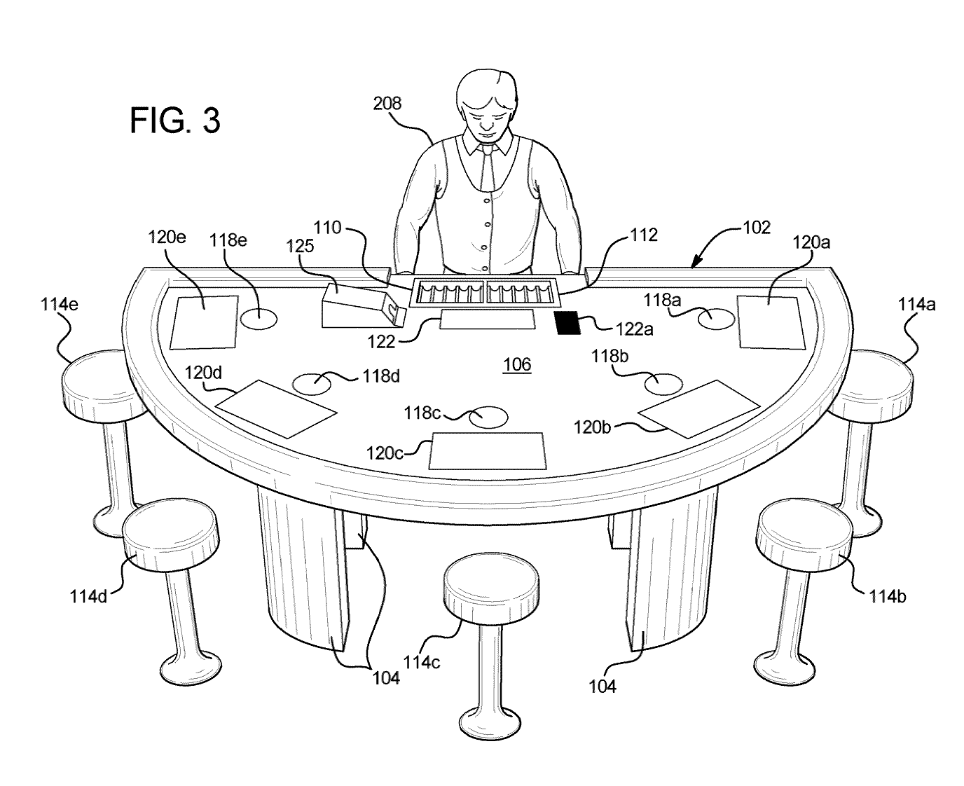

Referring now to FIG. 3, in one embodiment, the gaming system disclosed herein includes at least one intelligent gaming table such as gaming table 102. In one embodiment, the gaming table 102 includes a suitable support structure 104, such as one or more legs 104, and a suitable playing surface 106. In one embodiment, the playing surface 106 includes a dealer position 108 having one or more chip trays 110 and 112 for holding several stacks of the dealer's chips. The dealer may use the chip trays to collect and store wagering chips, to provide awards to the player for winning game outcomes, or to make change for a player. In one embodiment, the gaming table 102 further includes a plurality of player positions such as player seats 114a, 114b, 114c, 114d and 114e. In this example, there are five player positions or seats. It should be appreciated that in various embodiments, the intelligent gaming table 102 includes any suitable number of player positions to accommodate any suitable number of players without interfering with game play.

In one embodiment, the gaming table includes a plurality of playing areas 116a, 116b, 116c, 116d and 116e, in which the dealer deals the cards and the players handle the cards (if allowed by the rules of the game played at the gaming table 102). In one embodiment, each playing area 116a, 116b, 116c, 116d, and 116e corresponds with one of the gaming stations or seats 114a, 114b, 114c, 114d, or 114e of the gaming table 102. In certain embodiments, the gaming table 102 additionally includes wagering areas 118a, 118b, 118c, 118d, and 118e in which players place wagers on plays of a game facilitated by the gaming table 102. In one embodiment, each wagering area 118a, 118b, 118c, 118d, or 118e corresponds with one of the playing areas 116a, 116b, 116c, 116d, or 116e and one of the gaming positions or seats 114a, 114b, 114c, 114d, or 114e of the intelligent table 102. It should be appreciated that in one embodiment, the gaming table also includes a community wagering area (not shown) in which a plurality of players may each place an individual wagers on an occurrence of a designated game event.

In one embodiment, the gaming table includes a dealer playing area 122 located in association with the dealer position 108, wherein any cards dealt or otherwise provided to the dealer are placed during a play of the game. In a further embodiment, the dealer playing area 122 includes a down-card revealer 122a, which enables the dealer to determine a value of a down-card without lifting or otherwise turning over the down-card during a play of the game. In one embodiment, the down-card revealer 122a includes a mirror and a viewing area, such that by positioning a face-down playing card over the mirror, the dealer can see the value of the card in the viewing area. In another embodiment, the down-card revealer 122a includes an image sensor, such as a bar-code reader or a camera and associated image recognition software, which is configured to determine the value of a card placed adjacent to the down-card reader.

In one embodiment, the intelligent gaming table 102 includes a card distributor 125, such as a card shoe configured to simultaneously hold at least one deck of playing, and to enable the dealer at the dealer position 108 to remove and deal a top card from the deck(s) of playing cards. In one embodiment, wherein the card distributor 125 is a card shoe, the card shoe includes suitable hardware for tracking cards as they are removed from the shoe and dealt to the players and/or the dealer. For example, the shoe 125 includes a camera for capturing an image of each card removed from the shoe as it is removed, or includes a bar-code scanner for scanning bar codes printed on the cards as they are removed from the shoe.

In one embodiment, the shoe 125 enables the dealer to deal cards to himself or herself and to the plurality of players at the plurality of player positions 114a, 114b, 114c, 114d, and 114e. In one embodiment, the dealer deals a first card to one of the plurality of players, and continues dealing in a counter-clockwise direction until a designated number of cards have been distributed to each player and to the dealer. In one embodiment, the dealer places each card in one of the playing areas 116a, 116b, 116c, 116d, and 116e or the dealer playing area 122 such that cards dealt to a first player position are not confused with cards dealt to a second different player position.

It should be appreciated that in various embodiments, the gaming table 102 enables any suitable card-based game or any suitable non-card game, such as Roulette or craps to be played by one or more players. In various embodiments; the gaming table 102 includes any suitable devices necessary to track the plays of the card game or non-card game enabled by the table 102. It should be appreciated that different gaming tables in the gaming system may include the same game components as the gaming table 102 illustrated in FIG. 3, or may include one or more different game components as required to track the physical gaming elements needed to play the particular game being provided.

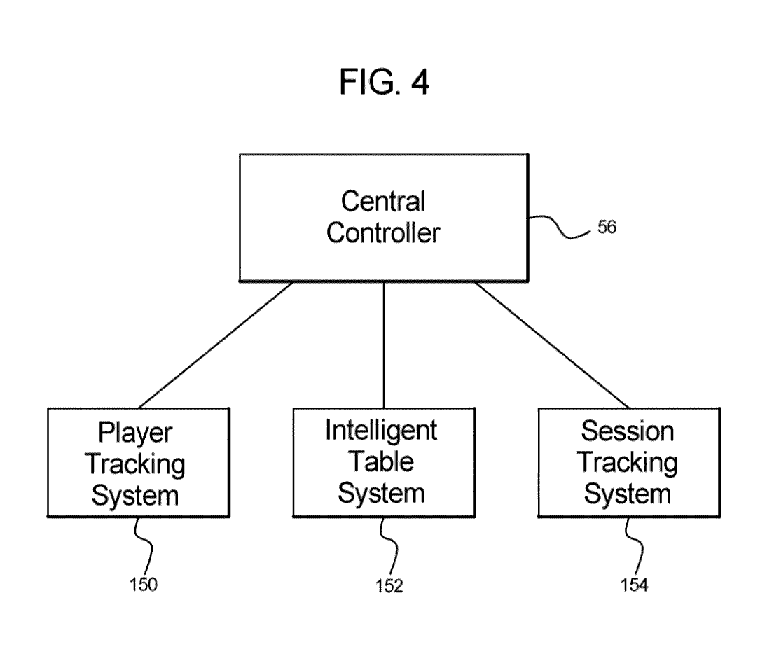

As illustrated in FIG. 4, in one embodiment, the gaming system disclosed herein includes a central controller 56 in signal communication with a plurality of components or sub-systems of the disclosed gaming system. In the illustrated embodiment, the central controller 56 includes, is in communication with, or is integrated with a player tracking system 150, an intelligent table system 152, and a session tracking system 154. In various embodiments, two or more of the player tracking system 150, the intelligent table system 152, the sign manager system 154, and the session tracking system 156 are combined to form a single sub-system of the disclosed gaming system.

In one embodiment, as described above, the central controller 56 is integrated with one or more player tracking systems 150. In this embodiment, the central controller 56, co-acting with the player tracking system 150, is configured to track the gaming activity of one or more participating players at one or more gaming tables such as gaming table 102. In one such embodiment, the central controller 56 and/or the associated player tracking system 150 timely tracks when a player inserts his or her player tracking card to begin playing a suitable game or removes his or her player tracking card to cease playing at the gaming table. That is, in one embodiment, the gaming system, the individual player station at the gaming table, and/or the associated player tracking system tracks any detected card-in/card-out during a player's gaming activity.

In another embodiment, the dealer logs one or more players in and out of the player tracking system as appropriate based on the players' gaming activities. In one such embodiment, when a player begins his or her gaming activity (such as by wagering on a first play of a game), the player hands a player tracking card or other tracking indicator to the dealer, and the dealer logs the player in to the gaming system. Likewise, when the player wishes to cease gaming activity, the dealer logs the player out of the gaming system and/or the player tracking system 150. In another embodiment, the gaming system enables the player to enter an input to indicate that the player is beginning or ending gaming activity, such as using a keypad or other appropriate input device. In different embodiments, the gaming system works in accordance with the player tracking system 150 to maintain the above-described data about one or more players engaging in gaming activity using the gaming system.

In various embodiments, rather than requiring a player to insert a player tracking card or requiring the player or dealer to manually enter identifying information, the gaming system disclosed herein includes a gaming table 102 which is configured to communicate with one or more portable devices carried by a player, such as a cell phone, an email communication device, a radio frequency identification (RFID) tag, or any other suitable wireless device to track when a player begins and ends a gaming session. In other embodiments, the gaming table 102 utilizes any suitable biometric technology or ticket technology to track when a player begins and ends a gaming session.

In one embodiment, the central controller 56 is additionally configured to operate with at least one intelligent table system 152 to track one or more physical gaming elements used by a player or a gaming establishment to provide a play of a table-based game. In one embodiment, an intelligent table system 152 includes one or more gaming tables such as gaming table 102. In a further embodiment, each gaming table of the intelligent table system 152 includes any suitable number of player input tracking devices, such as card readers or keypads, usable by the player tracking system 150 to enable the gaming system to track player gaming activity. In one embodiment, each player station or seat 114a, 114b, 114c, 114d, and 114e includes an individual player tracking input device. In another embodiment, a gaming table includes a single player tracking input device. In another embodiment, only a dealer has access to the player tracking input device and inputs all of each player's information.

In a further embodiment, the intelligent table system 152 includes at least one device for tracking the movement of one or more physical gaming elements on a gaming table such as gaming table 102. It should be appreciated that the intelligent table system disclosed herein may include any suitable components or devices needed to monitor any appropriate aspect of the players' gaming activity. That is, the intelligent table system 152 in one embodiment tracks one or more of the amounts wagered by a player, a number of chips a player wagers, an amount a player has won or lost, an amount of chips the player has on the gaming table, the player's session score for one or more gaming sessions, or any other desired trackable gaming information. In one embodiment, the intelligent table system 152 tracks this information for each and every game played by the player. In one embodiment, the intelligent table system is integrated directly with the player tracking system to enable players to be identified. In another embodiment, the communication between the intelligent table system 152 and the player tracking system 150 is facilitated by and controlled through the central controller 56. The intelligent table system 152 may include any suitable gaming table areas with chip identification devices, any suitable method of identifying the wagering chips, and may use any suitable chip reading technology.

In one embodiment, the central server tracks the number of and/or types of chips wagered at the gaming tables in the gaming system during a plurality of plays of a primary game. In one embodiment, different denominations of chips are visually different, such as having the value displayed on the chip, having different sizes and/or having different weights. In this embodiment, the gaming system tracks the different chips wagered by the players based on these visual (e.g., sizes, colors, etc.) and/or physical (e.g., weight) differences. In another such embodiment, each chip is associated with one of a plurality of different unique values detectable by the intelligent table system 152. In this embodiment, the intelligent table system 152 identifies the values of the individual chips (such as using RFID technology described herein), determines the placement of each chip based on the unique values detected, and sends the information to the player tracking system 150 or central controller 56 about each of the specific chips. In one embodiment, the central controller 56 associates the value of the chip with the player tracking account maintained by the player tracking system 150.

The intelligent table system 152 disclosed herein is operable to use a variety of types of technology to track player activity. More specifically, in one embodiment, the intelligent table system 152 includes one or more chip identifying devices for identifying chips wagered, won, and lost by one or more players of the disclosed gaming system. In one embodiment, the intelligent table system 152 uses infra-red (IR) signals received from table game chips to track activity. In another embodiment, the intelligent table system 152 employs RFID to track chip activity. In this embodiment, each chip includes a small electronic device (an RFID chip), and the gaming table 102 includes one or more antennae to track chips. The gaming table 102 determines the amount of a player's wager based on the RFID signals received from the chips when such chips are placed in an appropriate wagering area (i.e., a wagering area in close proximity with an RFID antenna), such as wagering areas 118a, 118b, 118c, 118d, or 118e.

In one embodiment, the gaming system associates detected gaming activity (such as wagering activity) with one or more players using one or more player accounts maintained by the gaming system. For example, at the start of play, a player logs into a player tracking system, such as by inserting a player tracking card into a card reader associated with their player station on the gaming table 102. In this embodiment, the gaming system associates any appropriate future tracked data (e.g., data about that player's wagering activity, wins, losses, the duration of the player's gaming activity, etc.) with that player's account. Thus, in certain embodiments, tracking player activity at the gaming table is similar in accuracy and thoroughness to the tracking enabled by conventional non-table game (e.g., reel-based slot machines) operating in conjunction with player accounts.

In certain embodiments, the intelligent table system 152 includes one or more playing card readers or a playing card reading system for detecting the manipulation of playing cards by players and/or dealers. The playing card reading system in one embodiment is configured to determine each playing card as the dealer removes it from the shoe 125 to deal to the appropriate player or the dealer. For example, the intelligent table system 152 uses one or more cameras or image capture devices to obtain a visual representation of a gaming element, and includes software configured to analyze the visual representation and determine the specifics of the gaming element. In one such embodiment, as discussed above, a card distributor 125 such as a card shoe includes a camera to capture an image of each card removed from the shoe, and further includes software to determine the value of such removed cards.

In one embodiment, the playing card reading system is a part of the intelligent table system 152 disclosed herein. In another embodiment, the playing card reading system is separate from the intelligent table system 152 and is configured to operate with the intelligent table system to determine the cards dealt by the dealer at a gaming table such as gaming table 102. In one embodiment, such determination of the cards dealt by the dealer enables the gaming system disclosed herein to detect betting patterns and decisions made by individual players. In a further embodiment, the gaming system stores data indicating these patterns and decisions in the player tracking system.

In various embodiments, the gaming system disclosed herein tracks one or more of player cards, dealer cards, and player wager amounts, and is configured to determine correct payouts for each hand and to each player at the gaming table 102. In one embodiment, such playing card tracking, which is enabled by the playing card reading system, further enables the gaming system to detect and reduce dealer error and/or corruption by ensuring that players receive the proper cards and are paid properly according to the cards they receive. For example, the gaming system in one embodiment is configured to send a halt play signal to the dealer or another employee of a gaming establishment (such as a pit boss) if an error is detected. It should be appreciated that in different embodiments the card reading system and the intelligent table system are integrated with or included in a same gaming system as one or more tracking systems or player tracking systems.

In another embodiment, the intelligent table system 152 disclosed herein employs a virtual gaming table configured to enable one or more players to interact with virtual representations of gaming elements to play a game. The virtual gaming table displays virtual playing cards and/or virtual wagering chips, and enables one or more players to play one or more games by manipulating these virtual representations of gaming elements. In one embodiment, the virtual gaming tables includes at least one processor programmed to operate with one or more surface computing mechanisms, one or more cameras, and one or more display devices to enable players to play such games. In one such embodiment, an intelligent gaming table includes an acrylic top and employs a plurality of infrared cameras and a DLP projector with Wi-Fi and BLUETOOTH™ wireless networks to display and detect virtual representations of physical gaming objects. In this embodiment, as players move their hands and/or appropriate physical objects on the table top, the cameras translate the motions into commands, and the commands update the images displayed by the display device. One such example of this type of table is the SURFACE™ table developed by Microsoft Corporation. SURFACE is a trademark of Microsoft Corporation and BLUETOOTH is a trademark of Bluetooth SIG, Inc.

Referring still to FIG. 4, in one embodiment the gaming system disclosed herein includes a session tracking system 154 for tracking the progress of one or more gaming sessions that span one or more plays of the primary game. In one embodiment, the session tracking system 154 operates in conjunction with the central controller 56, the player tracking system 150, and the intelligent table system 152 to track one or more physical gaming elements during plays of a primary game, to increment session scores as described herein, and to store information about gaming sessions in conjunction with player tracking accounts. In another embodiment, the central controller 56 operates with one or more gaming devices to provide non-table games, including displaying video or mechanical representations of gaming elements. In this embodiment, the central controller 56 further operates with a session tracking system 154 to track the progress of any active gaming sessions, and with a player tracking system to store results of wagering activity and session activity in association with one or more player accounts. It should be appreciated that in various embodiments, the gaming sessions described herein are operable with any suitable combination of devices to enable players to win primary game awards for plays of a primary game and to win secondary awards for sessions spanning a plurality of plays of the primary game.

In one embodiment, the session tracking system 154 is also configured to compare determined session scores to one or more payout tables, the payout tables including a plurality of tiers, wherein each tier includes at least one session score and at least one associated session award. In this embodiment, depending on the determined session award, the session tracking system 154 indicates the appropriate award to the central controller 56 for providing to the player.

It should be appreciated that in various embodiments the session tracking system 154 is further configured to provide the features of the gaming sessions described below.

### Session Game Spanning a Plurality of Plays of a Primary Game

In one embodiment, the gaming system disclosed herein enables one or more players to participate in a primary or base game for which the primary game outcomes are quantifiable (i.e., a value representative of each outcome can be assigned to that outcome). In one embodiment, the gaming system also enables the players to participate in a concurrent secondary game, wherein the concurrent secondary game is a session game spanning or including a plurality of plays of the primary game. In this embodiment, the outcome of the session game represents an aggregation of the outcomes of the plurality of plays of the primary game. During the gaming session, the gaming system quantifies each of the plurality of spanned or included plays of the primary game and determines whether to increase a session score for the gaming session based on each such play of the primary game. For example, for each play of the primary game, the gaming system adds a value representative of the primary game outcome to the session score. In this embodiment, the gaming system enables the player to make decisions in each of the plurality of plays of the primary game which can affect the quantifiable outcomes of the plays of the primary game, and as such the session score for any then-active session. In one embodiment, at the conclusion of the gaming session, the gaming system determines a session award (if any) based on the session score attained in the gaming session. In one embodiment, the gaming system enables one or more sessions to be simultaneously active, such that a single play of the primary game potentially increases the session score of a plurality of different sessions.

In one embodiment, the gaming system and methods disclosed herein provide the player with a primary game wherein a player can make multiple decisions each resulting in optimal play or sub-optimal play. That is, certain player decisions are optimal, and certain player decisions are sub-optimal, with respect to the primary game. The gaming system and methods disclosed herein also enable a player to make optimal and sub-optimal decisions with respect to the gaming session. That is, the gaming system and methods enable the player to make multiple decisions which, on average, result in an optimal session score, and to make decisions which, on average, result in a sub-optimal session score. In one embodiment, optimal session play includes a strategy which results in a maximum possible session score. In another embodiment, optimal session play includes a strategy which results in a minimum possible session score. It should thus be appreciated that the gaming system disclosed herein enables a player to make strategy decisions during the plurality of plays of the primary game which impact both the outcomes of the plurality of plays of the primary game and the session score for any then-active gaming sessions spanning or including the plays of the primary game. In one example, playing optimally with respect to the primary game results in sub-optimal play with respect to the session score. In another example, playing optimally with respect to the session score results in sub-optimal play with respect to the primary game. Thus, in one embodiment, the gaming system enables a player to elect to play optimally with respect to either the primary game or the secondary game, but not both. In a further embodiment, the gaming system enables the player to utilize one or more aspects of skill in an effort to develop the most exciting gaming strategy for a gaming session spanning a plurality of plays of a primary game.

Table 1, included herein, indicates a plurality of different types of decisions potentially makeable by a player for each of a plurality of plays of a primary game. Specifically, Table 1 illustrates that for each play of a primary game, a decision to be made by a player can result in various combinations of optimal and sub-optimal play with respect to both the primary game and the gaming session.

TABLE 1

| | Primary Game | Gaming Session |
|---|---|---|
| Decision 1 | Optimal | Optimal |
| Decision 2 | Optimal | Sub-optimal |
| Decision 3 | Sub-optimal | Optimal |
| Decision 4 | Sub-optimal | Sub-optimal |

In one embodiment, whether a play of the primary game is optimal or sub-optimal with respect to the primary game is determined based on one or more paytables associated with the primary game. That is, a paytable indicates an average expected payback percentage or payout percentage of the primary game for each decision a player makes, such as a decision whether to hit or stand for a play of a blackjack game. Based on a decision which the paytable indicates has the most favorable average expected payback, the gaming system in one embodiment determines whether the actual decision made by a player is an optimal or a sub-optimal decision. In one embodiment, a payout table associated with a gaming session defines whether a decision made during a play of a primary game is optimal or sub-optimal with respect to the gaming session. That is, the payout table defines an average expected payback with respect to the gaming session for each decision made in the primary game, which enables the gaming system to determine whether a decision made during a play of the primary game is optimal or sub-optimal with respect to the gaming session.

In one embodiment, the gaming system disclosed herein enables a player to participate in one or more gaming sessions, wherein each gaming session spans a plurality of plays of a conventional blackjack game. In one embodiment, the gaming system provides any appropriate primary game awards for a plurality of plays of blackjack according to the cards held by a player and the cards held by a dealer at the end of each play. In a further embodiment, the gaming system also determines a value indicative of each of the plays of blackjack, the value representing a quantification of that play. In one embodiment, the gaming system determines a session score for a gaming session spanning a plurality of plays of blackjack, such as by adding each of the values of the plurality of plays spanned by that session. The gaming system then provides any appropriate session award based on the determined session score for the gaming session.

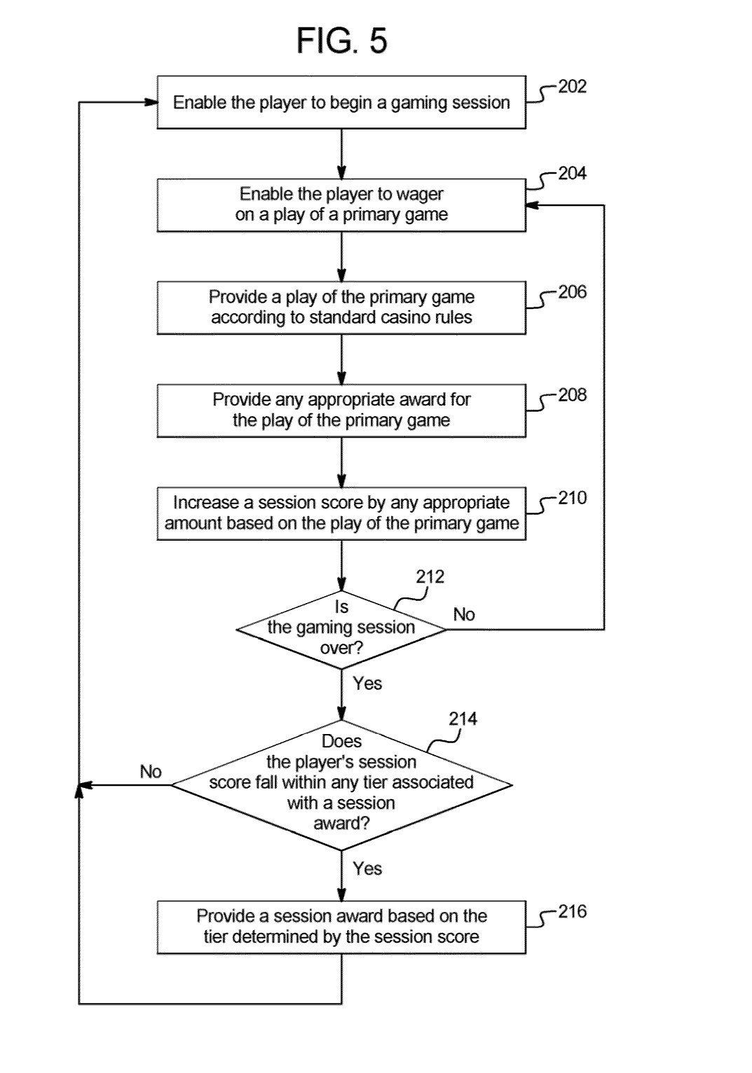

FIG. 5 illustrates a flow chart of an example process 200 for tracking or providing session gaming according to the instant disclosure. It should be appreciated that the process 200 illustrated by the flow chart of FIG. 5 describes a method for providing gaming sessions wherein at most a single gaming session is active at any given time during a period of gaming activity. In various embodiments, the gaming system disclosed herein is configured to simultaneously track and provide awards based on a plurality of overlapping gaming sessions. It should be further appreciated that while the example process 200 illustrates a session in which a single player is participating, the gaming system disclosed herein is configured in one embodiment to provide one or more gaming sessions which span a plurality of simultaneous or overlapping plays of a primary game by a plurality of different players.

In the illustrated embodiment, the gaming system enables a player to elect to participate in and begin a gaming session, as indicated by block 202. In one such embodiment, the gaming system enables the player to begin such a gaming session by placing a gaming session wager. In an example embodiment, the gaming system enables the player to place a wager to begin a session spanning a plurality of hands of blackjack, wherein each hand of blackjack is played according to standard blackjack rules. Alternatively, the gaming system enables a player to begin a gaming session by redeeming a promotional prize, such as a free gaming session prize provided to the player by a gaming establishment. In one embodiment, the gaming session wager is attributed to any potential future gaming session award, such that the gaming session wager funds the gaming session.

In one embodiment, the gaming system also enables the player to wager on a play of a primary game, as indicated in block 204. For example, the gaming system enables the player to place a wager on a hand of blackjack. In various embodiments, each wager on a play of the primary game is separate from any wager provided to begin (and fund) the gaming session as discussed with respect to block 202. In one embodiment, upon receiving an appropriate wager on a play of the primary game, the gaming system enables the player to play the primary game according to a standard set of rules for that game. It should be appreciated that in one example embodiment, the gaming system disclosed herein enables the player to begin a gaming session, as indicated by block 202, and wager on a play of the primary game (such as a hand of blackjack), as indicated by block 204, substantially simultaneously.

In one embodiment, upon receiving an appropriate wager on a play of the primary game, the gaming system provides the play of the primary game, as indicated by block 206. For example, the gaming system enables the player to play a hand of a blackjack game in exchange for the wager on the play of the primary game. In one embodiment, the gaming system enables this play of the hand of blackjack by tracking a plurality of playing cards physically dealt to the player and to a dealer. In another embodiment, the gaming system enables this play of the primary blackjack game by displaying a plurality of cards to a player on an appropriate display device and enabling the player to manipulate the video representations of the cards using an appropriate input device. It should be appreciated that in one embodiment, because the gaming system enables the player to play a hand of blackjack, the player's decisions during the play of the primary game are determined, in part, by the standard rules of that game. For example, a player of the gaming system which enables a hand of blackjack is motivated, in part, by a desire to have cards whose total value is (1) less than twenty-two and (2) exceeds the total value of any cards held by the dealer.

In one embodiment, the gaming system provides the player any appropriate award for the wagered-on play of the primary game according to the standard game rules of that primary game, as indicated by block 208. For example, the gaming system provides the player of the standard blackjack game with an award if the total value of the cards of the player's hand exceeds the total value of the cards of the dealer's hand and does not exceed twenty-one, or if the dealer busts, at the end of a hand of blackjack. In one embodiment, since the award provided to the player is based, at least in part, on the standard rules of the primary game, the gaming system disclosed herein causes the player to try to maximize any awards won for the plays of the primary game during a gaming session.

In one embodiment, the gaming system increases or increments a session score associated with an active session based on the play of the primary game, as indicated by block 210. For example, for an active gaming session, the gaming system in one embodiment initially provides a session score of zero, and increments the session score according to the total values of the cards in the player's hand at the end of the play of the blackjack game. In one embodiment, the gaming system increments the session score by adding the total value of the cards in the player's hand to the current session score. In a further embodiment, the gaming system only adds this total value of the cards in the player's hand to the session score if that total value does not exceed twenty-one (i.e., if the player did not bust). In one embodiment, a gaming session represents an aggregate amount of success of a player in a primary game over a plurality of plays of that primary game.

In one embodiment, after providing any appropriate primary game award, as indicated by block 208, and appropriately increasing the session score (if at all), as indicated by block 210, the gaming system determines whether the gaming session has ended, as indicated by diamond 212. For example, if a gaming session spans ten plays of the primary game (e.g., ten hands of blackjack), the gaming system determines whether the previous hand was the tenth hand of the gaming session. In one embodiment, if the gaming system determines that the gaming session has not yet ended, as indicated by diamond 212, the gaming system enables the player to again wager on a play of the primary game, as indicated by block 204, and provides the play of the primary game according to the standard game rules, as indicated by block 206.

If, after providing the appropriate primary game award and increasing the session score (if at all) based on the primary game outcome, the gaming system determines that the gaming session has concluded, as indicated by diamond 212, the gaming system determines whether the player's session score results in a separate session award for the session spanning the plurality of plays of the game, as indicated by diamond 214. Specifically, in one embodiment, the gaming system determines whether the player's session score falls within one of a plurality of tiers associated with a session award. For example, if the gaming session spans ten hands of a standard blackjack game, the gaming system determines whether to provide any session award to the player by comparing the player's session score at the end of those ten hands to a payout table, such as a payout table including a plurality of tiers of session scores, as indicated by block 214. In one embodiment, if the player's session score is too low (i.e., if the session score does not fall within any tier of the tiered payout table which is associated with a session award), the gaming system again enables the player to begin a gaming session by placing an appropriate wager, as indicated by block 202.

If the player's session score falls within a tier of the payout table which indicates that a session award is to be provided, the gaming system in one embodiment provides that session award to the player, as indicated by block 216, and enables the player to begin another session, as indicated by block 202. For example, if a player's session score is sufficiently large to indicate that a sufficient number of blackjack hands of relatively high value were obtained during the gaming session, the gaming system provides the player with an appropriate session award. Thus, in one embodiment, the gaming system disclosed herein tracks and maintains a session score, and awards players for achieving winning streaks, wherein an interim bad or losing hand does not adversely impact the player.

It should be appreciated that in one embodiment, the tiers of session scores are arranged such that only players with relatively high session scores, indicating that the player obtained a plurality of relatively favorable outcomes in the primary game, are provided with a session award. In another embodiment, the gaming system aggregates the session score such that players whose session scores indicate relatively poor performance over the course of a plurality of plays of the primary game are provided with session awards. For example, in one embodiment a player receives a relatively low session score. In this embodiment, the tier associated with the range in which the relatively low session score falls is associated with a relatively high session award. In this embodiment, the gaming system provides the session award to the player as an award based on poor play (or poor luck) in the primary game. For example, in one embodiment the highest session award available to a player is associated with a tier which is only available if the player receives a plurality of blackjack hands with an average hand value of four or less.

It should be appreciated that the gaming system providing session gaming as described with reference to the illustrated process 200 enables a single player to participate in a single active gaming session at a time. That is, the gaming system operating according to the process 200 enables the player to begin a new session after completing the previous session.

In one alternative embodiment, the gaming system disclosed herein enables a player to simultaneously participate in a plurality of gaming sessions. In this embodiment, the gaming system enables the player to begin a first session, such as by placing an additional side wager on a gaming session. For a first play of the primary game, the gaming system adjusts a first session score of the first session (if at all), based on the outcome of the first play of the primary game. Thereafter, the gaming system enables the player to elect to begin a second gaming session, despite the fact that the first session has not yet concluded. For example, the gaming system enables the player to place a wager to activate or begin a second gaming session after playing only a single hand of the first gaming session. For a second play of the primary game which occurs while both the first and second sessions are active, the gaming system adjusts either or both of the first session score and a second session score associated with the second session (if at all) based on the outcome of the second play of the primary game. Thus, if a player has caused a plurality of sessions to be simultaneously active (such as by wagering on more than one gaming session) a single play of the primary game can result in a change to the session scores of a plurality of different gaming sessions. In one embodiment, the gaming system does not limit the number of sessions which can be simultaneously active. In this embodiment, the gaming system enables the player to continue activating sessions for each play of the primary game, such that the maximum number of sessions simultaneously active is limited only by the length of each session. For example, if each session spans ten plays of a primary game, the gaming system enables a player to have as many as ten sessions simultaneously active, and provides awards based on the session scores of each session as that session ends or expires.

In one embodiment, the gaming system disclosed herein enables a player to participate in a plurality of gaming sessions simultaneously, wherein at least two of the plurality of gaming sessions span or include a same set of plays of the primary game. For example, the gaming system enables a player to simultaneously participate in a first gaming session and a second gaming session, wherein the first gaming session and the second gaming session each span a same set of ten plays of the primary game. In one such embodiment, the gaming system determines session scores differently for each of the simultaneous gaming sessions spanning or including the same set of plays of the primary game. For example, the gaming system increments the session score for a first gaming session based on the cards initially dealt to the player, and increments the session score for a second gaming session based on the cards initially dealt to the dealer. In another embodiment, the gaming system provides a session award based on different payout tables for each of the simultaneous gaming sessions. For example, the gaming system provides a first session award for the first gaming session based on a first payout table and a second session award for the second gaming session based on a second payout table, wherein the first payout table is different from the second payout table. It should be appreciated that any configuration of an individual gaming session discussed below can be utilized to provide simultaneously active gaming sessions, whether those simultaneous gaming sessions are totally overlapping or only partly overlapping.

In another embodiment, the gaming system disclosed herein enables one or more sessions which span a plurality of plays of a primary game, but wherein the plays of the primary game of a single session are not each played by a same player. In one such embodiment, two players are each wagering on plays of hands of blackjack at a same gaming table. In this embodiment, the gaming system enables one or more gaming sessions in which each player's primary game activity contributes to the session score (and thus to the session award, if any) for a same gaming session. For example, the first and the second player may each elect to begin a session in which both players participate. In this example, each player also wagers on a first play of the primary blackjack game. The dealer deals the cards, and the gaming system tracks the total value of each player's first hand. The gaming system then increments the session score (if at all) based on the total value of the cards in the first player's hand and the total value of the cards in the second player's hand. For example, if the first player receives cards having a total value of twenty, and the second player busts, the gaming system increments the session award by twenty, and determines that two hands of the primary game have been played. It should be appreciated that in this embodiment, if a session spans ten hands of blackjack, the session may end before the dealer has dealt cards ten different times—that is, since each instance of the dealer dealing cards may result in more than one hand of blackjack being played, the session may last for as few as five hands played by each of the players. In one embodiment, the gaming system enables one or more players to join a session already in progress. In another embodiment, the gaming system enables one or more players to start a separate session with a different set of players participating in the separate session. For example, if the first player and the second player are both simultaneously participating in a first session, the gaming system enables the first player to elect to begin a second session in which only the first player participates.

In one embodiment, the gaming system disclosed herein provides an award to a player based on one or more session scores regardless of whether player's hand of blackjack was a losing hand. That is, the gaming system provides an award to a player for receiving hands with relatively high values, even if the player lost plays of the primary game because the dealer had hands with higher values. For example, the gaming system rewards a player for obtaining a hand with a total hand value of twenty, regardless of whether the dealer obtained a hand with a value of twenty-one (which causes the player to lose that hand).

In various embodiments, as discussed above, the gaming system disclosed herein increments the session scores of one or more active gaming sessions based on a quantity representative of an outcome of a play of a primary game. In one such embodiment, the gaming system increments a session score by adding the total value of a plurality of cards in a player's hand at the end of a play of a card-based game, such as blackjack. In another embodiment, the gaming system increments a session score by adding the total value of a plurality of cards initially dealt to a player for a play of a card-based game. In one embodiment, the gaming system adds a minimum value to a session score if a total value of a plurality of cards in a player's hands exceed a predetermined maximum value. For example, if the cards in a player's hand for a play of a blackjack game exceed a total value of twenty-one, the gaming system increments a session score by a minimum value, such as five points. In one embodiment, a session score is incremented by a number between zero and nine representing the ones digit of the total value of the cards in a player's hand (i.e., by the total value of the cards in a player's hand modulo ten). In one embodiment, the gaming session increments the session score based, in part, on a number of cards in a player's hand at the end of a play of a primary game. In other embodiments, the gaming system increments a session score based on values on the faces of dice rolled in a dice-based game or on any other suitable quantifiable indicator or element used in a play of a primary game.

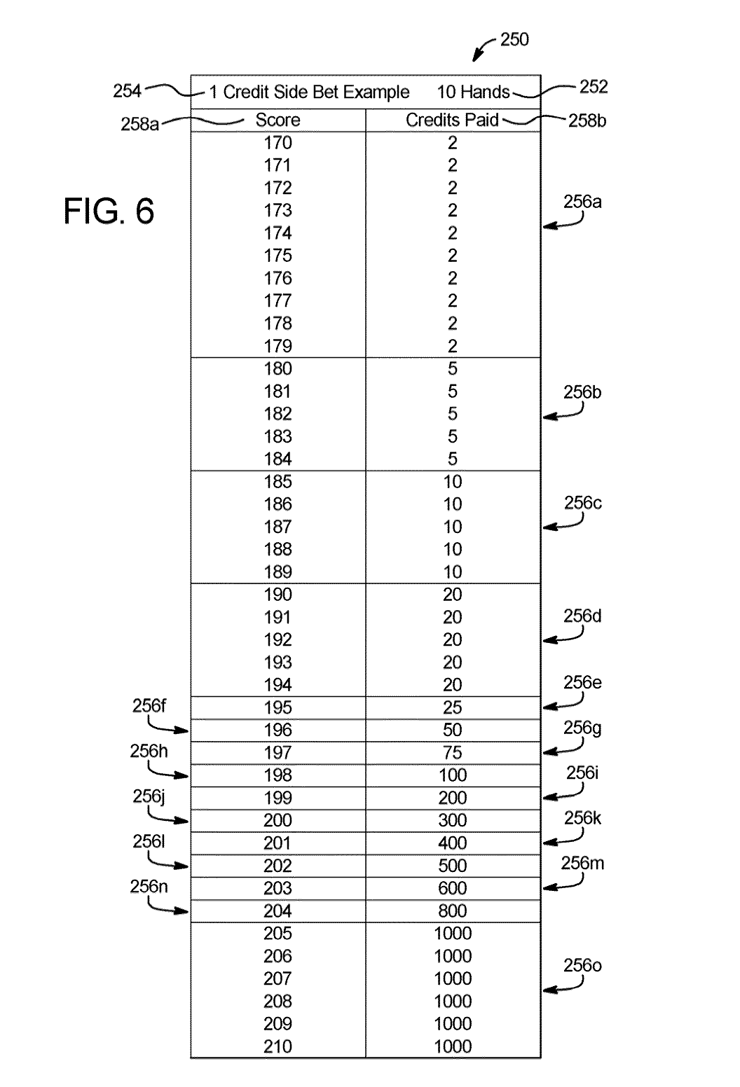

As noted above, the gaming system in one embodiment determines whether to provide any session award (and the value of any such determined session award) based on a payout table including a plurality of tiers of session scores and associated session awards. FIG. 6 illustrates an example representation of such a payout table 250. Specifically, table 250 is one embodiment of a payout table usable by the gaming system disclosed herein to determine whether to provide a session award for a session spanning a plurality of plays of a blackjack primary game. The gaming system utilizes such a table by determining which tiers of the table (if any) a session falls within, and providing an appropriate session award based on such a determination.

The table 250 is usable by a gaming system in one embodiment to determine awards for sessions spanning ten hands of a standard blackjack game, as indicated by session length indicator 252. Moreover, the gaming system uses the illustrated table 250 in one embodiment to provide session awards wherein, to activate a session, a player wagers one credit, as indicated by the session funding indicator 254. Table 250 of FIG. 6 includes a plurality of tiers 256a, 256b, 256c, 256d, 256e, 256f, 256g, 256h, 256i, 256j, 256k, 256l, 256m, 256n, and 256o. Each tier is indicated by one or more rows of data, wherein each row of data represents a possible session score and an associated session award. Specifically, each row of data includes a session score 258a and a session award 258b associated with that score. It should be appreciated that in the illustrated embodiment, the session award associated with each session score of a given tier is the same as the other session scores of the tier. Thus, in the embodiment illustrated by representation 250, if a player obtains a session score of one-hundred-eighty-five for a session spanning ten hands of blackjack, the gaming system determines that the player has achieved a session score within tier 256c. Likewise, if a player obtains a session score of one-hundred-eighty-nine for a session spanning ten hands of blackjack, the gaming system determines that the player has achieved a session score within the same tier 256c. In either case, the gaming system determines that a session award of ten credits is owed to the player and provides such a session award. In alternative embodiments, the table 250 includes a plurality of different tiers, or includes tiers with a plurality of different awards, depending on the number of hands of blackjack of a single session, the side bet required (if any) to activate a session, or any other appropriate factors of the gaming system.

It should be appreciated that the tiers illustrated in table 250 indicate that as the session scores achieved by a player for a session of plays of the primary game increase (and corresponding higher tiers are achieved), the session award paid to the player at the end of the session also increases. Thus, if a player achieves a session score of one-hundred-seventy-eight, the player receives a relatively small award of two credits. If, on the other hand, the player achieves a session score of two-hundred-five, the player receives a relatively high session award of one-thousand credits.

It should be appreciated that in one embodiment, wherein the session score for each hand of a standard game of blackjack is incremented by the sum of the values of the cards in the player's hand, the maximum increment for a single hand of blackjack is twenty-one points. Thus, for a ten hand session, the maximum session score available to the player is two-hundred-ten points, the occurrence of which results in an award from tier 256o. It should be further appreciated that in one embodiment, if a player busts for a play of a hand of blackjack (i.e., if the cards in the player's hand exceed a value of twenty-one), the gaming system does not increment the player's session score. Thus, if the player busts for each of the ten hands of blackjack which make up a session, the player receives a session score of zero. In the illustrated embodiment, the table 250 does not include entries for session scores below one-hundred-seventy. It should be appreciated that this is so because the gaming system does not provide an award for session scores of less than one-hundred-seventy. Therefore, a gaming system providing session awards according to the table 250 is configured to provide players with non-zero session awards if the players average seventeen or better for each of a plurality of hands of blackjack which make up a session.

It should be appreciated that the tiers illustrated in table 250 are merely illustrative of one embodiment of the gaming device. In various embodiments, the arrangement of the tiers varies depending on the funding of the session awards, the length of the sessions, or the logic used to increment the session scores. In other embodiments, the session scores in each of the tiers are predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In the illustrated embodiment, if a player of the gaming system utilizing the payout table 250 busts for a single one of the ten hands of blackjack in a session spanning ten hands, the maximum session score attainable by the player is one-hundred-eighty-nine (i.e., two-hundred-ten minus twenty-one). Thus, it should be appreciated that for certain players, the disclosed gaming system incentivizes conservative blackjack play, such that the player does not bust, as a single bust causes the maximum session award available to the player to shrink from one-thousand credits (for an award within tier 256o) to ten credits (for an award within tier 256c). Further incentives and disincentives provided in various embodiments of the present gaming system are discussed in detail below.

In one embodiment, the gaming system disclosed herein includes a gaming table such as table 102 of FIG. 3. In this embodiment, the gaming system enables one or more players to play the disclosed game, including the primary game and associated gaming sessions, by tracking the gaming activity at the gaming table 102. Specifically, if the primary game is a blackjack game, the gaming table 102 tracks the physical cards that are dealt to the players and the dealer, and tracks the wagers made by the players using physical markers such as casino chips during the plays of the game. In one such embodiment, based on the positions of the players at the gaming table 102, the disclosed gaming system tracks the total value of cards in each player's hand, the value of the cards in the dealer's hand, whether each player wins each hand of blackjack, an amount of credits wagered and won for each hand of blackjack, and an ongoing session score over a plurality of hands of blackjack. In one embodiment, at any point in time, the gaming system can determine the value of each card dealt to any player or the dealer, and the amount wagered by each player. Moreover, at any point in time, the gaming system in one embodiment can determine the session score of each active session for each player at the gaming table 102. In a further embodiment, some or all of this tracked information is stored in a player tracking system, such that data about past session play by the players is available in the future.

In the embodiment wherein the gaming system includes a table such as gaming table 102, the gaming system itself does not provide any awards to the players. Rather, the gaming system in one embodiment determines what awards to provide to the player, and relies on an employee of the gaming establishment that operates the gaming table 102 to provide the award. In an example embodiment, the gaming system includes a display (not shown) to indicate to a dealer whether to provide any session award to any of the players at the table. It should be appreciated that in one embodiment, the gaming system does not indicate to the dealer whether to provide any primary game awards to each player—rather, the gaming system relies on the dealer to make such determinations. In this embodiment, since the session scores would be difficult for a human dealer to track, the gaming system indicates what the session scores are and instructs the dealer to act accordingly. It should be further appreciated that if the gaming system includes a display for communicating pertinent information to the dealer, the gaming system may be configured to indicate to the dealer when problems occur during plays of the game. For example, the gaming system may be configured to indicate to the dealer if the dealer has improperly counted a player's cards, if a player has altered his or her wager, if the players at the table have switched cards, or if any other error occurs.

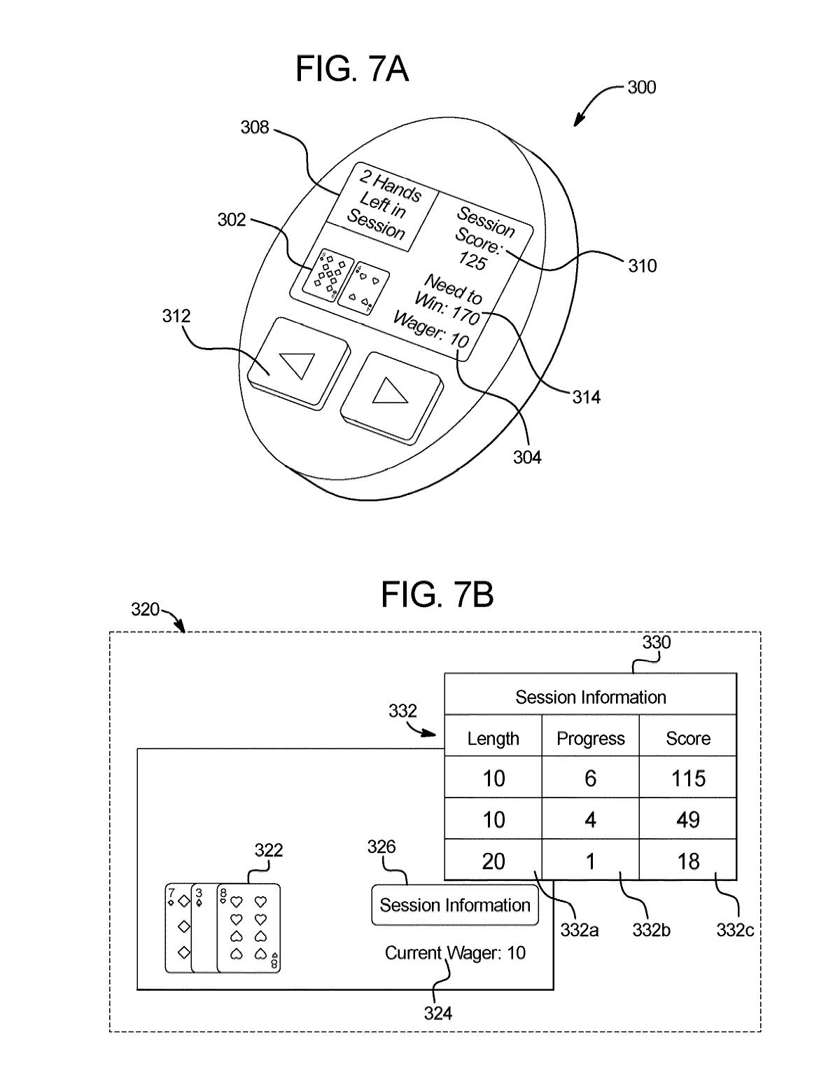

In one embodiment, in addition to providing information to the dealer during the plays of the primary game disclosed herein, the disclosed gaming system also enables each of a plurality of players wagering on plays of the primary game to view and/track his or her current session score(s) using a player-specific session score tracking device. One such session score tracking device is illustrated in FIG. 7A. In this embodiment, each of a plurality of players is provided with a session score tracking device such as session score tracking device 300. In one embodiment, the session score tracking devices 300 are permanently affixed to a gaming table such as the gaming table 102 of FIG. 3. In another embodiment, the session score tracking devices 300 are configured to wirelessly communicate with a transmitter/receiver contained within a table 102, such that placing a session score tracking device on or near a table 102 enables such communication. In one embodiment, each of the player positions 114a, 114b, 114c, 114d, and 114e is equipped with a session score tracking device 300.

In another embodiment, a plurality of players are provided with personal session score tracking devices 300 which the players place on any table at which the player wishes to play the game disclosed herein. In this embodiment, each player's session score tracking device 300 is associated only with that player, such that when a player sits down at a table to play a table game, the gaming system displays any appropriate information regarding that player's currently-active session(s) on the player's personal session score tracking device 300.

In one embodiment, session score tracking device 300 includes a current hand indicator section 302, which indicates the cards in a current blackjack hand. In one embodiment, the current hand indicator section 302 is updated in real time to reflect any cards dealt to a player and/or any cards received by the player during the play of the blackjack hand. In one embodiment, the session score tracking device 300 also includes a current wager indicator section 304, which displays the player's current wager. The gaming system may track this wager amount by determining any chips placed in the wager area 118a, 118b, 118c, 118d, or 118e using, for example RFID technology.

In one embodiment, the session score tracking device 300 further includes a session progress indicator section 308, which indicates the number of hands remaining in an active gaming session. In one embodiment, the session score tracking device also includes a session score display area 310 which displays the current session score. In one embodiment, the session score tracking device 300 additionally displays to the player a score needed to win display area 314 which indicates the minimum session score needed to win a session award. In the illustrated embodiment, the minimum session score needed to win display area 314 indicates that a minimum score needed is one-hundred-seventy. It should be appreciated that in the illustrated embodiment, the ten hand session illustrated by the session score tracking device 300 corresponds with the tiered payout table 250 of FIG. 6. In one embodiment, if a currently accumulated session score exceeds the minimum needed to win illustrated in area 314, the gaming system instead displays a session score indicative of the minimum needed to win an award in a next highest tier. For example, if session score indicated in the display area 310 indicates a value of one-hundred-seventy-two, the needed to win display area 314 displays a value of one-hundred-eighty, which is indicative of the value needed to achieve an award in the next-highest tier of the tiered payout table 250.

It should be appreciated that the information displayed in the session progress indicator section 308 and the session score display area 310 in one embodiment enable the player to determine whether and to what extent the player can win session awards. For example, in the illustrated embodiment, the session progress indicator section 308 indicates that the player has two hands remaining in the current session. The session score display area 310 indicates that the player has a current session score of one-hundred-twenty-five. It should be appreciated that the player's maximum possible session score in the illustrated embodiment is one-hundred-sixty-seven (i.e., if the player receives session scores of twenty one for each of the remaining two hands of the session). Since the needed to win display area 314 indicates that the player needs one-hundred-seventy points to receive a session score, the player in the illustrated embodiment cannot win a session award for the current gaming session. It should thus be appreciated that the player may determine, based on data displayed by the session score tracking device 300, that it is impossible to win a session award for the current session, and may accordingly employ gaming strategy to maximize the primary game awards won for the plurality of hands of blackjack as discussed in further detail below (such as a more aggressive blackjack strategy). Alternatively, if the gaming system enables the player to elect to end a session early in exchange for a returned portion of any wager placed on the gaming session, the player may elect this option in the illustrated embodiment.

In one embodiment, the session score tracking device 300 displays a real-time representation of a maximum attainable session award, such as a maximum attainable session award based on a maximum attainable session score and according to a tiered payout table such as payout table 250. In one embodiment, the session score tracking device 300 includes suitable inputs such as inputs 312 to enable a player to navigate the session information for more than one session in which the player is currently participating. It should be appreciated that inputs 312 in various embodiments are any suitable inputs for enabling interaction with the session score tracking device 300.

In another embodiment, illustrated by FIG. 7B, the gaming system disclosed herein is configured to provide each of the plurality of players at the table 102 with a display screen such as display screen 320. In this embodiment, the display screen 320 displays pertinent information about each of that player's currently active gaming sessions. In the illustrated embodiment, the display screen 320 includes a current hand display area 322 for displaying the cards contained in the player's current hand. In one embodiment, the display screen 320 also includes a current wager display area 324 for displaying the player's wager amount for the current play of the game.

In one embodiment, if a player selects session information button 326 displayed on the display screen 320 (such as by touching the screen if the screen is equipped with a touch screen controller), the gaming system displays a popup screen such as session information screen 330. In one embodiment, session information screen 330 includes a table 332 for displaying the pertinent session information of each of any then-active sessions in which the player is participating. In the illustrated embodiment, the table 332 includes a session length column 332a which indicates the total number of plays of the primary game spanned by each active session, a session progress column 332b which indicates the number of plays of the primary game which have already occurred for each active session, and a session score column 332c which indicates a real-time current session score for each active session. It should be appreciated that in the illustrated embodiment, the session information screen 330 indicates that the player is currently participating in three active sessions, wherein a first session spans a total of ten hands of blackjack, a second session spans a total of ten hands of blackjack, and a third session spans a total of twenty hands of blackjack. As further indicated in columns 332b and 332c, the player has already played six hands of the first session, four hands of the second session, and one hand of the third session. The scores for the three sessions are one-hundred-fifteen, forty-nine, and eighteen, respectively.

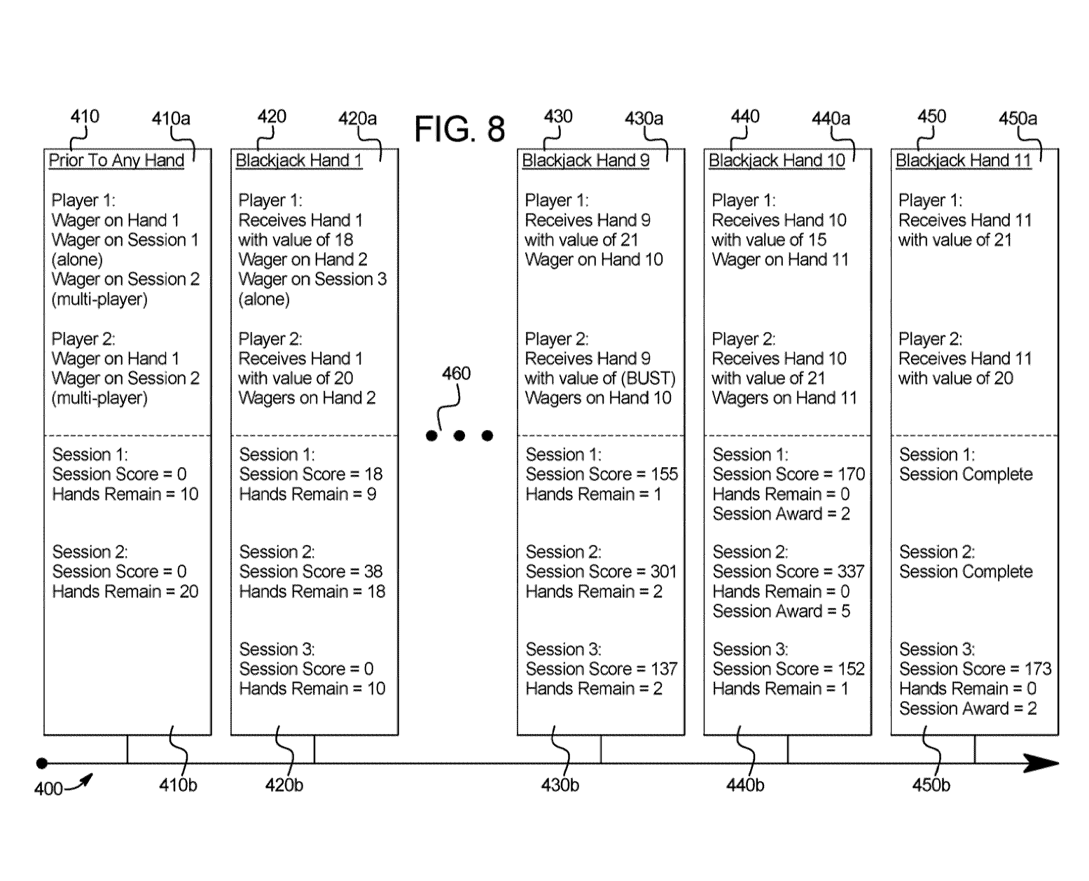

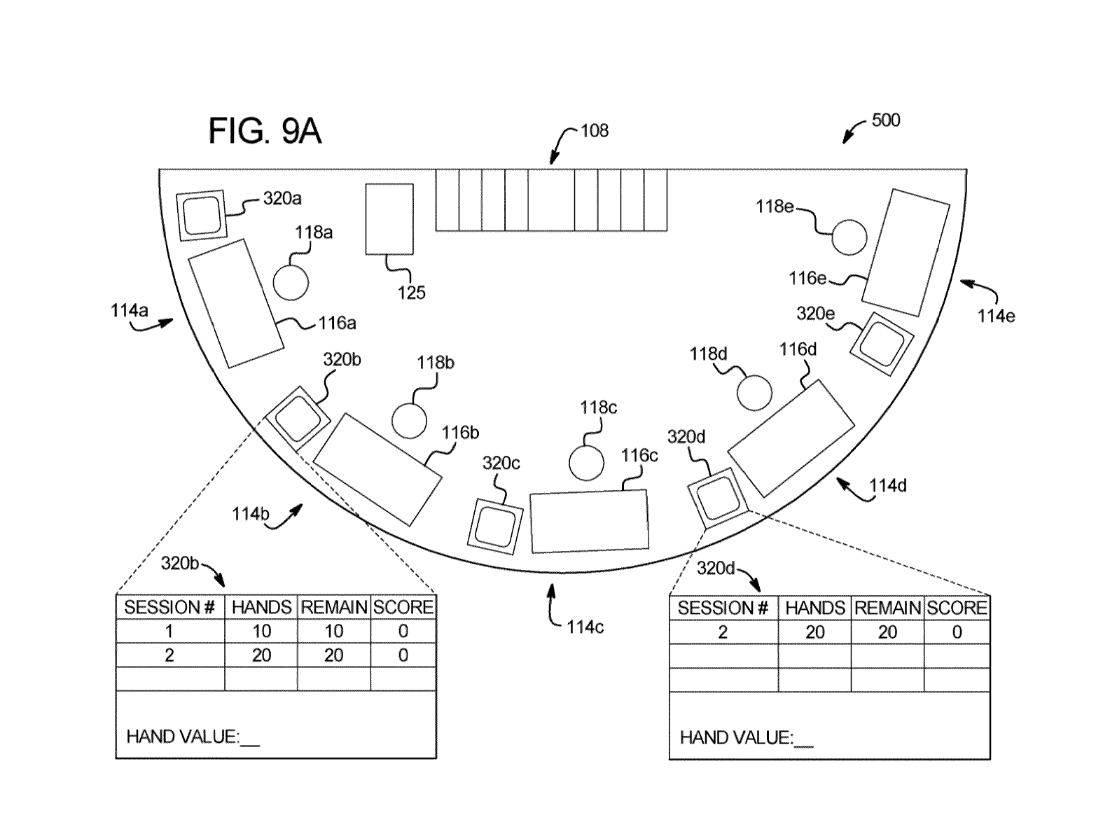

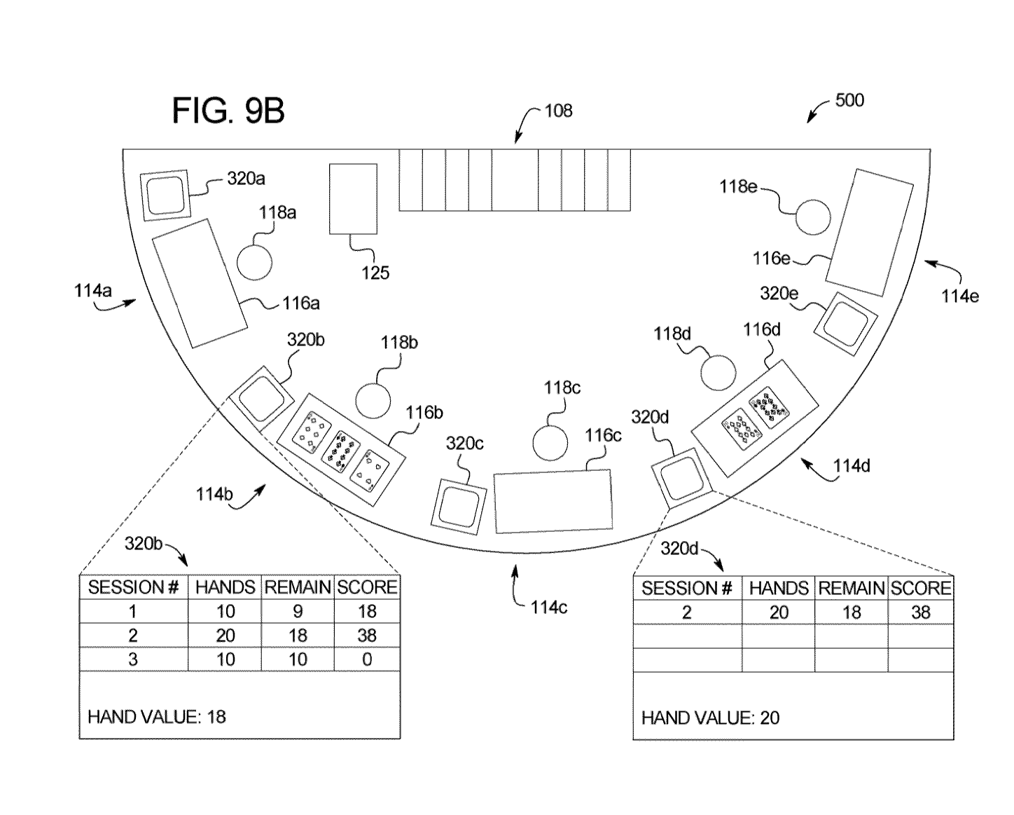

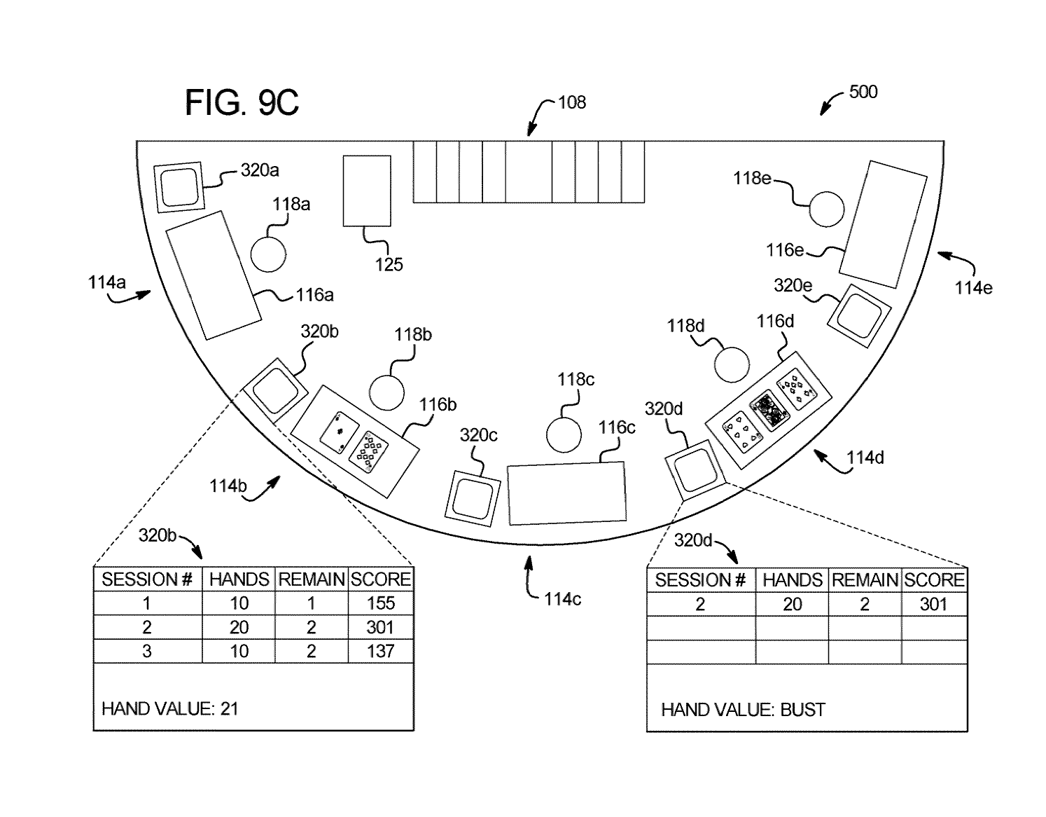

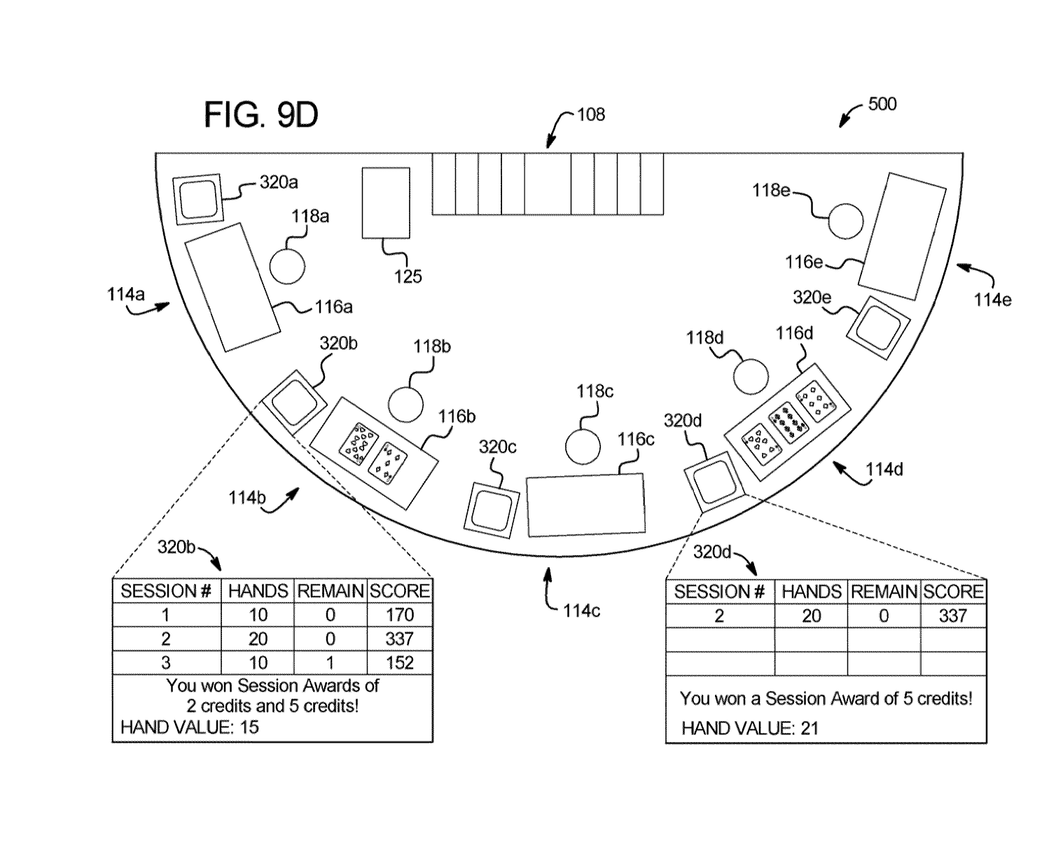

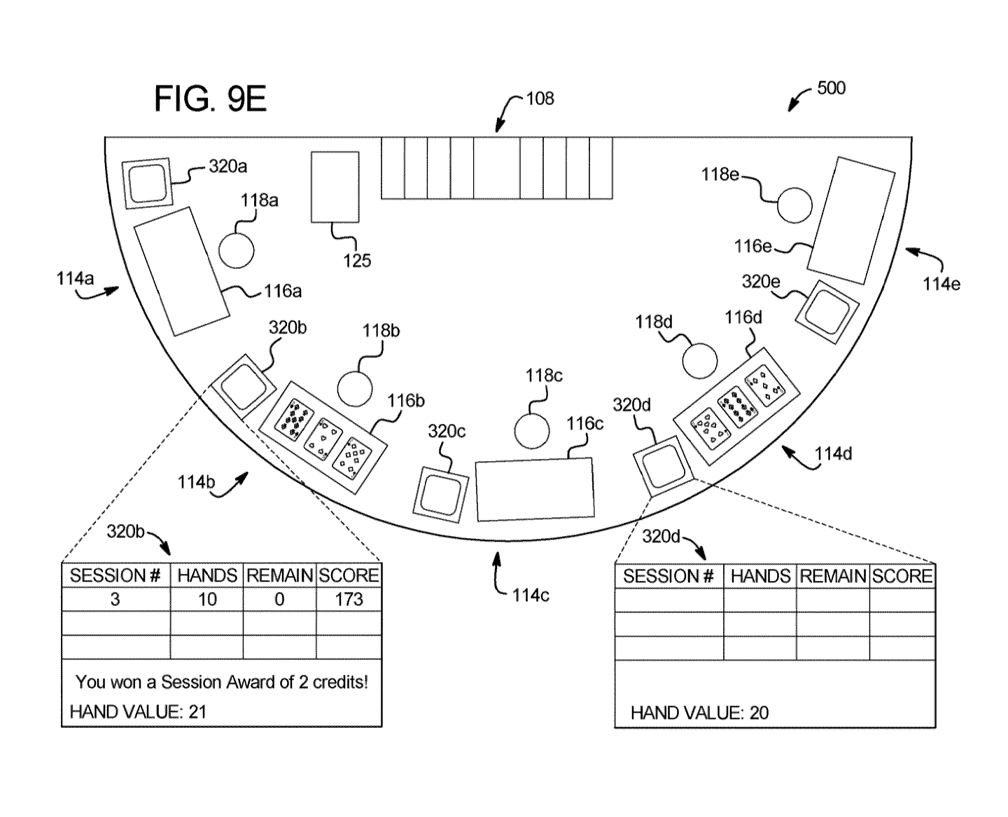

FIG. 8 illustrates an example timeline 400 of a plurality of plays of the primary game disclosed herein, wherein at various points in time, one or more gaming sessions is in progress for one or more players. FIGS. 9A, 9B, 9C, 9D, and 9E are schematic representations of an example gaming system 500, which in one embodiment includes a gaming table 102 and the appropriate associated hardware to track a plurality of dealt cards and a plurality of wagers made by the players of the gaming system. In the illustrated embodiment, point in time 410 of FIG. 8 corresponds with the schematic representation of the gaming table 102 illustrated in FIG. 9A, point in time 420 of FIG. 8 corresponds with the schematic representation of the gaming table 102 illustrated in FIG. 9B, point in time 430 of FIG. 8 corresponds with the schematic representation of the gaming table 102 illustrated in FIG. 9C, point in time 440 of FIG. 8 corresponds with the schematic representation of the gaming table 102 illustrated in FIG. 9D, and point in time 450 of FIG. 8 corresponds with the schematic representation of the gaming table 102 illustrated in FIG. 9E.

FIGS. 9A, 9B, 9C, 9D, and 9E each illustrate a gaming system 500 which includes a gaming table 102. In the illustrated embodiment, the gaming system 500 is configured to enable as many as five different players to simultaneously wager on plays of blackjack primary games and corresponding gaming sessions. In the illustrated embodiment, the players can play at player positions 114a, 114b, 141c, 114d, or 114e. For each player, the gaming table 102 includes a playing area 116a, 116b, 116c, 116d, or 116e, in which the dealer places cards while dealing. Further, the gaming table includes a wagering area 118a, 118b, 118c, 118d, or 118e for each of the players. In one embodiment, for a play of the game, a player at table 102 places his or her wager (for example, by placing an appropriate amount and denomination of gaming chips) within the player's wagering area 118a, 118b, 118c, 118d, or 118e. In exchange for the wager placed by any active player, the dealer at dealer position 108 removes cards from the shoe 125 and places the cards in front of the appropriate player, as in a standard blackjack game. The gaming system 500 in one embodiment tracks the cards that are dealt to the players, the cards that are dealt to the dealer, and the wager(s) made by each player on the play of the game. Thus, the gaming system 500 stores information indicating which cards are in front of which player and the amount of any wager placed by each player at all times.

In the example embodiment illustrated in FIGS. 9A, 9B, 9C, 9D, and 9E, the gaming system 500 also includes a plurality of display devices 320a, 320b, 320c, 320d, and 320e. Each display device in one embodiment is associated with one of the player positions 114a, 114b, 114c, 114d, or 114e at the gaming table 102. In the illustrated embodiment, each display device is configured to display information to the player at the appropriate gaming position. In one embodiment, the information displayed to a player is player-specific information such as information about the amounts of any wagers made by the player, information about any cards that have been dealt to the player, and/or information about any active sessions in which the player is involved. In one embodiment, the player-specific display devices 320a, 320b, 320c, 320d, and 320e display information to the player as described above with respect to FIG. 7B. In a further embodiment, the player-specific display devices are also configured to operate with an appropriate touch-screen controller to enable the players to elect to begin one or more sessions for one or more plays of the primary blackjack game illustrated in FIGS. 9A, 9B, 9C, 9D, and 9E.

It should be appreciated that the gaming system illustrated in FIGS. 8, 9A, 9B, 9C, 9D, and 9E is illustrated as having the same two players playing for each play of the game. Specifically, the players are wagering on plays of the primary blackjack game at player positions 114b and 114d. In alternative embodiments, the disclosed gaming system enables one or more players to leave the game, join the game, or elect not to wager for a play of the primary game, or otherwise enables the number of players to change, for one or more plays of the primary game.

It should be further appreciated that in the embodiments of the gaming system illustrated in FIG. 8 and FIGS. 9A, 9B, 9C, 9D, and 9E, the specific results of the primary blackjack game are not illustrated. That is, the dealer's hand is not illustrated, the wager amounts by the players on the plays of the blackjack game are not illustrated, and any awards provided for the play of the blackjack game are not illustrated. It should be appreciated that such blackjack wagers/awards are provided in one embodiment according to standard blackjack rules, and are omitted in the illustrated embodiments to clarify the operation of the gaming system disclosed herein.

As indicated in FIG. 8 and FIG. 9A, point in time 410 is a point in time just before either of two players, Player 1 (playing at player position 114b) and Player 2 (playing at player position 114d), have received playing cards for a first hand of blackjack. Specifically, at point in time 410, as indicated in player information area 410a of FIG. 9, both Player 1 and Player 2 have wagered on a first hand of blackjack. As further indicated in player information area 410a, Player 1 has wagered on two gaming session—Session 1 and Session 2. Player 2 has wagered on a single gaming session—Session 2. In the illustrated embodiment, Session 1 is a session in which only Player 1 will participate. Session 2 is a multiple-player session, and both Player 1 and Player 2 will participate in Session 2.

As indicated in Session Information Area 410b, Session 1 has a session score of zero at point in time 410; it should be appreciated that this is the case because the gaming system has not tracked any blackjack hands which could potentially contribute an increase in the session score of Session 1. Moreover, single-player Session 1 has ten hands remaining. Similarly, Session 2 has a current session score of zero, as the gaming system has not tracked any blackjack hands which could potentially contribute to the session score of Session 2. Since two players are participating in Session 2, it should be appreciated that Session 2 has twenty hands remaining. It should further be appreciated that twenty hands remaining, for a session in which two players are participating, means in one embodiment that the session spans ten actual distributions of the cards by the dealer, as each distribution of the cards results in two hands being aggregated into the session score of Session 2.

As illustrated in FIG. 9A, at point in time 410, the gaming system 500 displays to Player 1 (playing at player position 114b) information about the sessions in which Player 1 is involved. Thus, in one embodiment the gaming system displays, on display device 320b, that Player 1 is participating in two gaming sessions, wherein the first gaming session will span a total of ten hands (of which ten hands remain) and wherein the first session score is currently zero. Similarly, the display device 320b displays information indicating that Player 1 is participating in a second session, wherein the second session will span twenty hands of blackjack (of which twenty hands remain) and wherein the second session score is currently zero. The display device 320b also displays an area in which the total value of the cards in Player 1's hand will be displayed. It should be appreciated that in various alternative embodiments, the display device 320b also displays information about other sessions (i.e., sessions in which Player 1 is not involved), the players involved in certain sessions (including sessions in which Player 1 is involved), or any other pertinent information to the session game disclosed herein. Display device 320d displays similar information to that displayed by display device 320b, although it should be appreciated that the information displayed by display device 320d indicates to Player 2 that Player 2 is involved in only a single session (i.e., Session 2) which spans twenty hands of blackjack, and in which twenty hands of blackjack remain to be played.

Referring again to FIG. 8, the timeline 400 indicates that at point in time 420, Player 1 and Player 2 have each played a first hand of blackjack. Specifically, player information area 420a indicates that at point in time 420, Player 1 has received a single blackjack hand with a total value of eighteen. Moreover, at point in time 420, Player 1 wagers on a second hand of blackjack. Player information area 420a also indicates that at point in time 420, Player 1 wagers on a third session, Session 3, wherein Player 1 is the only player participating in the third session. According to player information area 420a, Player 2 received a hand for the first play of the blackjack game with a total value of twenty. Player 2 also wagered on a second hand of blackjack.

Session information display area 420b of FIG. 8 indicates that at point in time 420, the session score for Session 1 is eighteen, and that nine hands remain to be played for Session 1. It should be appreciated that since Player 1 is the only player participating in Session 1, the session score and number of hands remaining for Session 1 reflect only Player 1's gaming activity. Session information area 420b further indicates that for Session 2, in which both Player 1 and Player 2 are participating, the session score is thirty-eight, and eighteen hands remain. It should be appreciated that thirty-eight is the sum of the first hand values for Player 1 and Player 2, and that eighteen (of twenty) hands remain because Player 1 and Player 2 have each played a single hand of blackjack at the point in time 420. Finally, session information display area 420b indicates that a third session, Session 3, has been activated, that the session score for Session 3 is zero, and that ten hands (i.e., all of the hands of Session 3) remain to be played in Session 3.

FIG. 9B illustrates the gaming system 500, including the gaming table 102 for tracking the play of the primary blackjack game by Player 1 and Player 2, at point in time 420. Specifically, FIG. 9B illustrates that at point in time 420, Player 1 at player position 114b has received the indicated cards, with a total value of eighteen. FIG. 9B further illustrates that at point in time 420, Player 2 at player position 114d has received the indicated cards, with a total value of twenty. In the illustrated embodiment, the dealer's cards are not shown for clarity; it should be appreciated that in one embodiment, for the play of the game, the dealer receives at least two cards, and the cards held by the players at the end of the hand of blackjack are compared to the dealer's cards to determine any primary game wins for the play of the game.

As further illustrated in FIG. 9B, display device 320b indicates Player 1's status at point in time 420. Specifically, display device 320b indicates that Player 1's current hand has a total value of eighteen. Display device 320b further indicates the status of the sessions in which Player 1 is involved. Thus, display device 320b indicates that Session 1, which spans ten hands of blackjack, has nine hands remaining. Further, the session score for Session 1 at point in time 420 is eighteen, the session score being determined based on the sum of the cards in Player 1's hands. Display device 320b indicates that Session 2, in which Player 1 and Player 2 are both participating, has eighteen remaining hands and a session score of thirty-eight. It should be appreciated that the session score for Session 2 is based on the sum of the values of the cards held by Player 1 and the cards held by Player 2. Finally, display device 320b indicates that Session 3, which will span ten hands of blackjack, has just been begun. That is, Session 3 has all ten hands of blackjack remaining, and the session score of Session 3 is zero.

Display device 320d of FIG. 9B indicates that Player 2 has received a hand with a total value of twenty. Display device 320d further indicates the status of Session 2—the only session in which Player 2 is participating. That is, display device 320d indicates that Session 2, which will span twenty hands of blackjack, has eighteen hands remaining and a session score of thirty-eight based on the values of the current hands of Player 1 and Player 2.

Referring again to FIG. 8, the timeline 400 indicates (by the ellipses 460 between point in time 420 and point in time 430) that point in time 430 occurs more than a single hand of blackjack after point in time 420. Specifically, player information area 430a indicates that point in time 430 occurs after the ninth hand of blackjack. For the ninth hand of blackjack, player information area 430a indicates that Player 1 receives a hand with a value of twenty-one. Moreover, player information area 430a indicates that Player 2 receives a hand with a value which exceeds twenty-one. That is, Player 2 busted for the ninth hand of blackjack.

Session information area 430b indicates that for Session 1, in which Player 1 alone is participating, the session score after the ninth hand is one-hundred-fifty-five. Moreover, session information area 430b indicates that only one hand remains for Session 1. It should be appreciated that in one embodiment, the gaming system is configured to cause a session award to be provided to a player for a ten hand session if the session score for that session is equal to or exceeds one-hundred-seventy. Thus, in the illustrated embodiment, it should be appreciated that to receive a session award for Session 1, Player 1 needs to increase the session score of Session 1 by at least fifteen points for the last hand of that session. As discussed below, the desire to win a session award may shape Player 1's strategy regarding the last hand of blackjack of Session 1.

Session information area 430b further indicates that Session 2, in which both Player 1 and Player 2 are participating, has a session score of three-hundred-one with two hands remaining in Session 2. Finally, Session 3 has a session score of one-hundred-forty-seven, with two hands remaining. It should be appreciated that in the illustrated embodiment, Session 3 began one hand after Session 1. Thus, while Session 1 has only one hand remaining, Session 3 has two hands remaining. It should further be appreciated that since the first eight hands of Session 3 were common to Session 1 as well, the session score for Session 3 has a difference from the session score of Session 1 based upon the first hand of Session 1 (i.e., the only hand which Session 1 and Session 3 do not share).

FIG. 9C illustrates a schematic representation of gaming system 500 at the point in time 430. Specifically, FIG. 9C illustrates that display device 320b indicates to Player 1 the session statuses of Session 1, Session 2, and Session 3, in which Player 1 is participating. Further, display device 320b indicates that Player 1 has received cards with a total value of twenty-one for the illustrated play of the game. Playing area 116b, in which Player 1's cards are displayed, indicates that Player 1 received an ace and a ten for the play of the game, thus resulting in a total hand value of twenty one. Display device 320d also indicates the status of Session 2 to Player 2. It should be appreciated that Session 2 is the only session in which Player 2 is participating. Further, display device 320d indicates that for the illustrated blackjack hand, Player 2's cards had a total value which exceeded twenty-one (that is, Player 2 busted). Playing area 116d, in which Player 2's cards are displayed, indicates that Player 2 received a six, a queen, and a seven, for a total value of twenty-three. Since twenty-three exceeds twenty-one, the displayed cards result in a bust for Player 2.

FIG. 8 indicates that point in time 440 follows the tenth hand of blackjack in which Player 1 and Player 2 are participating. In the illustrated embodiment, player information area 440a indicates that Player 1 received a tenth hand with a total value of fifteen. Player information area 440a further indicates that Player 2 received a tenth hand with a total value of twenty-one. Session information area 440b indicates that at point in time 440, Session 1 has a session score of one-hundred-seventy with zero hands remaining. As a result, the gaming system determines a session award of two credits for Session 1. It should be appreciated that this determination is made in one embodiment by comparing the session score achieved by Player 1 with a tiered payout table, such as the tiered payout table 250 of FIG. 6. Session display area 440b further indicates that the session score achieved for Session 2 by both Player 1 and Player 2 is three-hundred-thirty-seven, and that zero hands remain in Session 2. Thus, based on a similar payout table to payout table 250 of FIG. 6, the gaming system determines that a session award of five credits should be provided to Player 1 and Player 2. Finally, session information area 440b indicates that Session 3 has achieved a current session score of one-hundred-fifty-two, and that a single hand remains to be played for Session 3.

FIG. 9D illustrates the gaming system 500 after the tenth hand of blackjack played by both Player 1 and Player 2. Specifically, game play area 116b indicates that for the tenth hand of blackjack, Player 1 received a hand with a total value of fifteen. It should be appreciated that in one embodiment, Player 1 elects not to hit again (despite having a relatively low blackjack hand) because if Player 1 had hit and busted, Player 1 would have lost both the primary blackjack award as well as the session award. That is, the session score would have remained at a value of one-hundred-fifty-five, and since the player busted for the hand of blackjack, the player could not have won the primary award.

Game play area 116d indicates that Player 1 received a hand with a total value of twenty-one for the tenth hand of blackjack. Display device 320b displays the pertinent session information to Player 1. Specifically, display device 320b indicates that for Session 1, in which Player 1 was participating, the session has expired or ended (i.e., zero hands remain). The final session score for Session 1 of the illustrated embodiment was one-hundred-seventy. Similarly, Session 2 has expired, with a final session score of three-hundred-thirty-seven. As discussed above, these session scores each result in a session award for Player 1, which the display device 320b indicates with the statement “You Won Session Awards of 2 credits and 5 credits!” Display device 320b further indicates that for still-active Session 3, one hand remains to be played and that the session score for Session 3 is one-hundred-fifty-two.

Display device 320d indicates that Session 2, in which Player 2 was participating, is completed (i.e., zero hands remain) and that the session score for Session 2 was three-hundred-thirty-seven. Moreover, display device 320d indicates that Player 2 won a session award with a value of five credits. It should be appreciated that despite the cards having a total value of twenty-one being displayed in the game play area 116d, Player 2 is not participating in any active sessions at the point in time illustrated in FIG. 9D.

Referring again to FIG. 8, point in time 450 is illustrated as occurring after an eleventh hand of blackjack played by Player 1 and Player 2. As illustrated in player information area 450a, Player 1 receives an eleventh hand with a value of twenty-one. Player 2 receives an eleventh hand with a value of twenty. In the illustrated embodiment, neither Player 1 nor Player 2 wagers on another hand after the eleventh hand. Session information area 450b indicates that both Session 1 and Session 2 are complete for the eleventh hand. This is consistent with the discussion of Session 1 and Session 2 at point in time 440, which resulted in session awards for both Player 1 and Player 2.

Further, session information display area 450b indicates that the current session score for Session 3 is one-hundred-seventy-three, and that zero hands remain to be played for Session 3. That is, Session 3 has been completed at the point in time 450. In the illustrated embodiment, the gaming system compares the session score for Session 3 to a tiered payout table such as the table 250, and determines that a session award of two credits is appropriate for the achieved session score of Session 3. The gaming system causes the appropriate session award to be provided to Player 1—the only player participating in Session 3.

FIG. 9E illustrates the gaming system 500 at point in time 450. Specifically, at point in time 450, Player 1 receives cards for the play of the game having a total value of twenty-one, as indicated by game play area 116b. As indicated by display device 320b, Player 1 is participating in Session 3 at point in time 450. Session 3 has zero hands remaining, and has attained a session score of one-hundred-seventy-three. Based on this session score, the gaming system determines that a session award of two credits is appropriate by comparing the session score with a payout table such as payout table 250 of FIG. 6. Display device 320b indicates this session award. Display device 320d indicates that Player 2 is not currently participating in any active sessions—thus, it should be appreciated that Player 2 is only eligible to receive any primary game award available based on Player 2's blackjack hand. In the illustrated embodiment, that hand has a value of twenty, as indicated by game play area 116d.

In various embodiments, a gaming establishment utilizes the gaming system and method described herein to provide a primary blackjack game and a gaming session spanning or including a plurality of plays of the primary blackjack game to one or more players. The gaming establishment enables players to play blackjack with a minimum wager of ten dollars ($10.00) per play of blackjack. One of ordinary skill in the art will appreciate that depending on the rules and variations of blackjack employed by the gaming establishment, as well as the awards defined by the gaming establishment as being associated with certain outcomes of blackjack (e.g., the determined payback percentage for a wagered-on play of blackjack which results in the player being dealt a blackjack), the average portion of each wager on the play of blackjack which is returned to the wagering player, assuming the player plays optimally, varies. In one example embodiment, a gaming establishment enables players to wager on plays of a game wherein, if the players play optimally, the average expected payback percentage for each wager is 99.2%. That is, for a wager of ten dollars on a play of blackjack, a player playing optimally wins, on average, nine dollars and ninety-two cents ($9.92). Moreover, for ten hands of blackjack on which a total of one-hundred dollars ($100.00) is wagered, the player playing optimally wins, on average, ninety-nine dollars and twenty cents ($99.20), and the gaming establishment retains, on average, eighty cents ($0.80) of the player's wagers. It should be appreciated that the math described above presumes that the player is playing optimally with respect to the blackjack game alone—that is, the player is attempting to win each hand of blackjack by making the probabilistic best play, without regard for the session scores of any gaming sessions.

In one example embodiment, such as the embodiment described above with respect to FIGS. 8 and 9A, 9B, 9C, 9D, and 9E, the disclosed gaming system funds any session awards provided to the players for participating in gaming sessions by enabling the players to place separate side wagers to activate or participate in such gaming sessions. In this embodiment, a gaming establishment provides any session award for a gaming session spanning a plurality of plays of a primary game at the conclusion of that gaming session based on a session score achieved during the course of the gaming session using amounts received as side wagers on one or more gaming sessions.

In this example embodiment, the gaming system enables players to participate in gaming sessions in exchange for providing a gaming session wager of five dollars ($5.00). In exchange for the gaming session wager, the gaming system provides players with session awards (if any) by comparing a session score at the end of a gaming session with a payout table. In this example embodiment, the payout table results in an average expected session award of five dollars and thirty-four cents ($5.34) for each gaming session, assuming the player plays optimally with respect to the gaming session. That is, the player receives an average session award of five dollars and thirty-four cents ($5.34) if the player attempts only to maximize the session award during the plays of the primary game (i.e., the player hits and stands without regard for the outcomes of the plays of blackjack which make up the gaming session).

In the example embodiment discussed above, it should be appreciated that a player's decision to play optimally with respect to the plays of blackjack reduces the average expected payback percentage for side wagers or wagers on gaming sessions. Likewise, it should be appreciated that a player's decision to play optimally with respect to the wagered-on gaming session by attempting to maximize the session score reduces the player's average expected payback percentage for the plays of the primary blackjack game. For example, if a player has cards totaling fourteen and the dealer has a nine showing in a play of blackjack, the optimal play with respect to the blackjack game may be to hit, as the dealer's total cards are likely to exceed fourteen, and the player is likely to lose the hand of blackjack without hitting. The optimal play with respect to the blackjack game may be sub-optimal with respect to the gaming session. In this example, hitting on a hand totaling fourteen has a relatively high probability of resulting in a bust, which may result in a relatively small amount of additional points being added to the session score (e.g., zero points). In this example, a player attempting to maximize a session score, on the other hand, may elect to stand, such that the session score is increased by fourteen points, despite the relatively higher likelihood of losing the hand of blackjack.

In another such example, wherein a player has a blackjack hand with cards totaling fourteen and wherein the dealer has a six showing, the optimal play with respect to an active gaming session (i.e., to maximize the session score) may be to hit. In this example, the optimal play for the same hand with respect to the blackjack game may be to stand, given that the dealer has a relatively high likelihood of drawing cards with a total value exceeding twenty-one, resulting in a dealer bust. As these examples indicate, depending on a player's intent, optimal strategy with respect to the blackjack game and optimal strategy with respect to the gaming session can be divergent. Thus, the gaming system disclosed herein increases player excitement and enjoyment by enabling the player to elect one optimal strategy or the other, or by enabling the player to attempt to discern an overall optimal strategy with respect to both the primary game and the gaming session.

In one embodiment, playing optimally with respect to the blackjack game results in an average return to the player of 99.2% of each wager on a play of blackjack, but results in an average return to the player of only 80.0% of each wager on a gaming session. In this embodiment, therefore, optimal play with respect to the blackjack game for a session spanning ten hands of blackjack requires the player to wager one-hundred-five dollars ($105.00) (i.e., ten dollars ($10.00) on each of ten plays of blackjack and five dollars ($5.00) on the gaming session spanning those ten plays of blackjack), and results in an average expected total return to the player of one-hundred-three dollars and twenty cents ($103.20) (i.e., an average expected return of ninety-nine dollars and twenty cents ($99.20) on the ten plays of blackjack, based on the 99.2% blackjack expected payback percentage for optimal play with respect to the blackjack game, and an average expected return of four dollars ($4.00) for the gaming session, based on the 80.0% session game expected payback percentage for optimal play with respect to the blackjack game). However, it should be appreciated that the available session awards may be relatively large, and as such the player may wager on the gaming session and still elect to play optimally with respect to the blackjack game in the hopes of maximizing the awards won on the blackjack game and further in the hopes of winning the relatively large session award. In one embodiment, therefore, the disclosed gaming system increases player excitement and enjoyment by providing the opportunity to win potentially large session awards.

In this example embodiment, playing optimally with respect to the gaming session (as opposed to the blackjack game) results in an average expected return to the player of 106.7% of each wager on a gaming session, but results in an average expected return to the player of only 97.5% of each wager on a play of blackjack. In this embodiment, therefore, optimal play with respect to the gaming session for a session spanning ten hands of blackjack requires the player to wager one-hundred-five dollars ($105.00), as above, and results in an average expected total return to the player of one-hundred-two dollars and eighty-four cents ($102.84) (i.e., an average expected return of ninety-seven dollars and fifty cents ($97.50) on the ten plays of blackjack, and an average expected return of five dollars and thirty-four cents ($5.34) on the gaming session). In this embodiment, the disclosed gaming system increases player excitement and enjoyment by enabling the player to maximize his or her likelihood of winning a relatively large session award for a gaming session in exchange for playing slightly sub-optimally with respect to the ten plays of blackjack spanned by that gaming session. Moreover, the gaming system disclosed herein increases player excitement and enjoyment by enabling the player to win session awards having a value which, on average, exceeds the player's wagers on the gaming sessions.

It should be appreciated that in this embodiment, wherein a player places a session wager to participate in a gaming session, the gaming establishment providing the disclosed gaming system and methods can utilize a payout table for the session awards which results in an average expected payback percentage to the player that is greater than 100% of the wager on a gaming session for a player playing optimally with respect to the gaming session, due to the associated reduction in average expected payback percentage for the plays of the blackjack game of the gaming session.

In another embodiment, the gaming system and methods disclosed herein provide players with opportunities to win session awards without requiring those players to place wagers on a gaming session. In this embodiment, a gaming establishment providing players with such opportunities to win session awards without requiring any wagers on the gaming sessions utilizes a different payout table for determining the values of any session awards won by players of the game than that described above. For example, the gaming system may utilize a payout table with a lower average expected payback percentage of session awards than the payout table utilized in the example discussed above in which the players wager to participate in a gaming session.

In an example of this embodiment, the gaming system provides a blackjack game having the same average expected payback percentage of 99.2% (assuming optimal play with respect to the blackjack game) as discussed above. Likewise, in this example, if a player plays optimally with respect to a session score (i.e., if the player makes decisions of whether to hit or stand in an effort to achieve the highest session score possible), the average expected payback percentage of each play of the blackjack game will be reduced to 97.5%.

In this example embodiment, the gaming system enables a player to participate in a gaming session without providing an additional wager on the gaming session. Moreover, in this example embodiment, the gaming system determines any session awards based on a payout table which provides an average expected payback of 0.8% of the wagers on the plays of blackjack. Thus, in one embodiment, the gaming system disclosed herein provides an average expected payback percentage of 100% if the player is playing optimally with respect to the blackjack game (i.e., on average, the player wins the full amount of each wager placed), based on the combination of the payback percentages for the plays of blackjack and the session awards won during any gaming sessions (i.e., based on the average expected payback percentages of 99.2% for the blackjack game and 0.8% for the gaming sessions, given optimal play with respect to the blackjack game).

In a further example embodiment, the gaming system rewards a player for playing optimally with respect to the gaming sessions by utilizing a payout table which results in an increased average expected payback percentage for such optimal play. For example, the gaming system provides, in the form of a session award, an average expected payback percentage of 1.07% of each of the wagers on the blackjack game, if the player plays optimally with respect to the session score for a gaming session. That is, the gaming system provides an increased average expected payback percentage if the player attempts to maximize his or her session score during a gaming session. As discussed above, playing optimally with respect to the session score may result in a reduced average expected payback percentage for each play of blackjack (i.e., an average expected payback percentage of 97.5%, as opposed to the 99.2% average expected payback percentage enjoyed during optimal blackjack play).

Thus, in an example embodiment, a player wagers ten dollars ($10.00) on each of a plurality of plays of blackjack and the gaming system enables the player to participate in a gaming session without providing an additional wager on the gaming session. In this embodiment, if the player plays optimally with respect to the blackjack game, the player receives an average expected payout of one-hundred dollars ($100.00) per session (i.e., an average expected payout of ninety-nine dollars and twenty cents ($99.20) from the plays of blackjack, and an average expected payout of eighty cents ($0.80) as a session award). However, if the player plays optimally with respect to the session score, the player receives an average expected payout of ninety-eight dollars and fifty-seven cents ($98.57) per session (i.e., an average expected payout of ninety-seven dollars and fifty cents ($97.50) for the plays of blackjack and an average expected payout of one dollar and seven cents ($1.07) as a session award). Thus, it should be appreciated that the gaming system disclosed herein increases player excitement and enjoyment by enabling the player elect to play optimally with respect to the session score, and to thereby increase the probability of receiving a relatively large session award.

It should be appreciated that in the example embodiments discussed above, a player playing optimally with respect to blackjack will receive a session award based on an accumulated session score approximately at an average rate of once every twelve gaming sessions. On the other hand, a player attempting to maximize his or her session score will receive a session award approximately once every nine gaming sessions. Thus, the gaming system enables the player to attempt to win the relatively large session awards approximately one third more frequently (i.e., once every nine sessions as opposed to once every twelve sessions) in exchange for a slight reduction in the average expected payback percentage for the blackjack game.

As discussed above, in various embodiments, wherein the gaming system disclosed herein requires players to place a wager on a gaming session, the average expected payback percentage of the gaming session can be relatively high (e.g., greater than 100%) if the player is trying to maximize the session award at the expense of the primary game awards. It should be appreciated that this relatively high average expected payback percentage of the session award is possible due to the fact that by attempting to maximize a session score, the player necessarily sacrifices optimal play in the primary game. Thus, while on average the gaming establishment may be providing awards exceeding wagers for the gaming sessions, the excess is made up for by the corresponding reduction in average expected payback percentage of the primary game.

Likewise, the disclosed gaming system enables a gaming establishment to provide players access to one or more gaming sessions without requiring the players to place a separate wager for the gaming sessions. In one embodiment, if a player of the gaming system disclosed herein plays optimally with respect to the gaming session (i.e., the player attempts to maximize the session score throughout a session), the increase in the average expected payback percentage for the gaming session is offset by the corresponding decrease in the average expected payback percentage of the multiple plays of the primary game with respect to that gaming session caused by sub-optimal play with respect to those plays of the primary game.

Thus, it should be appreciated that because optimal play with respect to the primary game results in sub-optimal play with respect to the gaming sessions, and because optimal play with respect to the gaming sessions results in sub-optimal play with respect to the primary game, certain embodiments of the gaming system disclosed herein increases player excitement and enjoyment by enabling players to either elect to win as much as possible in primary game awards, or to attempt to win the relatively larger, relatively rarer session awards. Moreover, it should be appreciated that the gaming system disclosed herein enables the gaming establishment to provide such a game either by receiving an additional wager on a gaming session and providing an average expected payback percentage for the session award exceeding 100% of the wager on the gaming session, or by not requiring the player to place any additional wager to participate in the gaming session (i.e., by providing free access to the gaming session).

Moreover, in an embodiment of the disclosed gaming system wherein the gaming system enables players to simultaneously participate in a plurality of different gaming sessions, it should be appreciated that the probability of receiving a session award after a given play of blackjack is increased based on the number of then-active gaming sessions. Thus, the gaming system disclosed herein enables players to attempt to win the relatively large session awards more frequently (in terms of the number of hands of blackjack) by causing multiple sessions to be simultaneously active.

In the embodiments described above, the primary game is a blackjack game, and the player has at least one choice to make (i.e., whether to hit or stand) for each play of the game. It should be appreciated that in the embodiment described above, wherein the gaming system does not require a wager to activate a session, the ability to provide such a gaming session without requiring a wager is predicated on the fact that it is possible for a player to make a sub-optimal decision during a play of the primary game. If, on the other hand, the primary game does not provide any choice to the player (e.g., if the primary game outcome for purposes of the gaming session is the value of the cards in the dealer's hand), the gaming system in one embodiment requires a side wager to participate in a gaming session. It should be appreciated that the reason the side wager is required is that the player is not faced with the choice of whether to pursue an optimal primary game strategy coupled with a sub-optimal gaming session strategy, or to pursue a sub-optimal primary game strategy coupled with an optimal gaming session strategy. Rather, no strategy is involved, and the relationship between the primary game and the gaming sessions is defined by set percentages.

It should be appreciated that the mathematics discussed in the example embodiments above is merely exemplary. It should be appreciated that differing mathematics can be utilized to provide players with awards more or less frequently, and to provide players with relatively larger awards or relatively smaller awards, depending upon the gaming experience desired by the players. Moreover, it should be appreciated that by varying the rules of the primary game (such as blackjack) or by varying the tables utilized to calculate session awards, the average expected awards achievable by the players can be varied according to a desired player experience.

In one embodiment, the gaming system funds any session awards provided to the plurality of players, at least in part, by allocating a portion of the players' wagers on the plays of the primary game to pay any session awards earned during any play of the game disclosed herein. In a blackjack embodiment, the gaming system provides session awards based on an increasing session award pool, such that a larger pool results in a larger possible session award. In one such embodiment, if a player plays according to optimal blackjack strategy (i.e., if the player plays such that the player has an optimal probability of winning), the gaming system allocates a relatively small percentage of each wager to a session award pool. For example, the gaming system allocates one half of one percent of the player's wager to a session award pool. If the player plays sub-optimally, the gaming system in one embodiment allocates a larger portion of the player's blackjack wagers to the session award pool. That is, if a player plays sub-optimally in an effort to accumulate points rather than to win blackjack hands, the gaming system in one embodiment allocates a larger percentage of each wager to the session award pool to account for the reduced likelihood that the player will win the primary game awards.

In an example embodiment, the gaming system disclosed herein is implemented, in part, in an intelligent table such as the table described above. In this embodiment, the intelligent table is configured to track multiple aspects of the game play, including the player's decisions with respect to the primary game (e.g., the decisions to hit, stand, split, double down, or purchase insurance), the context in which those decisions are made (e.g., the dealer's up-card when the player makes the primary game decisions), the player's wagering activity, and any pertinent session information. In one embodiment, the intelligent table also determines, for each play of the primary game, an optimal strategy with respect to that play of the primary game. For example, depending upon the cards in the player's hand and the dealer's up-card, the gaming system determines whether the optimal blackjack strategy is to hit, stand, double down, split, or purchase insurance.

In one embodiment, the intelligent table makes an assessment as to whether the player is playing according to the optimal strategy. In this embodiment, if the intelligent table determines that the player is playing according to the optimal blackjack strategy, the intelligent table allocates a relatively small percentage of each wager, such as 0.5% of each wager, to the session award pool. The determination as to whether a player is playing optimally may be based, in part, on the quantity of decisions made by the player which statistically provide the best blackjack result. In one embodiment, each decision made by the player need not be the optimal decision in order for the determination to be made that the player is playing optimally—rather, the intelligent table may give each player a threshold percentage of decisions which are sub-optimal, and may still arrive at the determination that the player is playing optimally.

In this embodiment, if the intelligent table determines that the player is not playing optimally (i.e., that the player is playing sub-optimally), the intelligent table next determines whether the player is being aggressive or conservative in his or her sub-optimal play. For example, the intelligent table may determine that the player is playing conservatively sub-optimally if the player stands on a hand with a total value of fourteen against a dealer's eight in an effort to accumulate session score points at the expense of being more likely to lose the hand of blackjack. In this embodiment, if the intelligent table determines that the player is playing conservatively sub-optimally, the gaming system allocates an increased percentage (e.g., 3.0%) of the player's wager on the play of the primary game to the session award pool. In this embodiment, the allocation of three percent of the player's wager is possible because of a corresponding reduction in the average expected payback percentage of each play of the primary game based on the sub-optimal play of the primary game. For example, conservative sub-optimal play may result in a 1.5% decrease in the average expected payback percentage of the primary game, and a such the gaming device may allocate 3.0% of the player's primary game wager to the session award pool.

In another embodiment, if the player plays aggressively sub-optimally, such as by electing to hit a hand with a total value of fourteen against a dealer six in an effort to accumulate larger session points scores, the intelligent table determines that the player is being aggressively sub-optimal. That is, the gaming system determines that the player is increasing the probability of busting during the primary blackjack game in an effort to increase the accumulated session score by a larger amount. In an example embodiment, the gaming system allocates a larger percentage of each wager on the primary game to the session award pool (e.g., 4.5%), as the aggressively sub-optimal play reduces the average expected value of each play of the primary game by a corresponding amount (e.g., 2.5%).

In various embodiments, the percentages of each wager on the primary game which are allocated to the session award pool for players playing sub-optimally (whether aggressively sub-optimally or conservatively sub-optimally) are determined by the extent to which the intelligent table determines the sub-optimal play impacts the average expected payback percentage of the primary game. In other embodiments, the percentages allocated to the session award pool are predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In another embodiment, the gaming system disclosed herein funds one or more session awards only if the players wagering on plays of the primary game wager a minimum session award eligibility amount for each play of the game. For example, if a gaming establishment provides a blackjack table which enables players to wager as little as five credits on a hand of blackjack, the gaming system disclosed herein may only fund the session award (and a player may only be eligible to win that session award) if the player wagers a minimum amount above the table minimum for a plurality of plays of the game. In one embodiment, the gaming system requires the player to wager an average of ten credits per hand, despite the table minimum being five credits per hand. In various embodiments, the minimum amount that a player must wager to be eligible for the session award is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In another embodiment, the gaming system funds one or more session awards based on amounts received from promotional entities, such as the gaming establishment which operates the gaming system. In one such embodiment, one or more sessions is provided to a player without a fee to the player (i.e., without requiring a side wager) as a promotion of an event, a gaming establishment such as a casino, a particular type of game, or other appropriate event. In another such embodiment, one or more non-gaming establishment sponsors provide access to one or more sessions, such that the sessions serve to advertise the non-gaming establishment sponsor. In various embodiments, whether the gaming session enables a player to engage in a gaming session without placing an additional side wager is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system disclosed herein funds any session awards, in part, based on a rake taken from a pot generated during one or more plays of a primary game. For example, in an embodiment wherein the primary game includes a poker game, the gaming system funds any session awards based, in part, on a rake taken out of each pot generated during the poker game. In various embodiments, the pot is generated by player activity such as anteing, wagering, or otherwise contributing to a pot during a play of the game. In various embodiment, the portion of the pot which is taken as a rake (i.e., to fund any session awards) is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, a gaming establishment provides a player with the opportunity to play a session for free during a plurality of plays of a primary game. For example, a casino rewards a customer staying in an associated hotel with the opportunity to win free session awards during play of a blackjack game in the casino. In one embodiment, the free session play is predicated on the player wagering at a designated wager level, such as ten credits for each hand of blackjack. In another embodiment, the gaming establishment enables the player to participate in session gaming only if the player plays the primary game during a designated time period, such as between 10:00 am and 1:00 pm.

In one embodiment, the combination of a standard game, wherein primary awards are provided based on each outcome of the game, with a gaming session as disclosed herein, alters the strategy decisions available to the player, thus increasing player excitement and enjoyment while playing the game. Specifically, since the primary award is based only on a single play of the game, a first play of the primary game does not necessarily impact the outcome of a second play of the primary game. Thus, standard games (alone) enable a player to make strategy decisions without considering the future impact of such decisions (and without considering past primary game outcomes). On the other hand, by including a gaming session as disclosed herein, wherein each of a plurality of plays of the primary game impacts the session score (and thus the session award), the disclosed gaming system in one embodiment requires players to additionally consider the impact of each decision made during a gaming session on the session score and corresponding session award. Therefore, if a player makes a concerted effort to increase the session award as much as possible, the player may be more conservative during a play of a blackjack game. For example, a player may take an additional card (i.e., a hit) during a play of a blackjack game if the session award was not available, despite a risk of the total value of cards exceeding twenty-one. This is because (a) the player may feel that there is not a very good chance to beat the dealer without running the risk of hitting and busting and (b) the player knows that even if he or she busts for a current play of the blackjack game, the player can always wager on a subsequent play and essentially start anew. On the other hand, if the play of the blackjack game is one of a plurality of plays of a game which makes up a gaming session, the player may be more reluctant to take an additional card because of the risk of busting. That is, if the player busts by exceeding a total hand value of twenty-one, the gaming system does not increment the session score at all. Thus, a risk taken in a first play of the primary game may adversely impact a future outcome of the gaming session. In one embodiment, therefore, the gaming system incentivizes conservative play to minimize the negative impact on the session score of busting during a play of a blackjack game.

In another embodiment, the gaming system incentivizes aggressive play during the gaming session disclosed here, as the gaming system rewards such aggressive play with increased session awards. For example, if a player is on the tenth play of a ten play session, and needs nineteen points to receive a relatively large award in a highest tier of a payout table, the gaming session may alter the player's analysis of the risk associated with playing the game disclosed herein. For example, if a player has a hand with a total value of twelve, and the dealer is showing a six, a single, discrete play of the blackjack game, played according to optimal strategy, may indicate that the player should not hit and risk busting. On the other hand, if the difference between the highest tier and the second highest tier is sufficiently large (i.e., the difference between a one-thousand credit session award and a one-hundred credit session award), the player may elect to risk busting in the current hand by hitting and taking an additional card in an effort to receive the top-tier session award. Thus, it should be appreciated that while the system disclosed herein in one embodiment does not require a player to learn additional rules to play a standard game, the system may alter the risk/reward determinations made by the player during the course of the gaming session, thus increasing player excitement and entertainment.

In one embodiment, one or more sessions enabled by the disclosed gaming system are limited to participation by a single player. In this embodiment, each player may activate one or more sessions, but only plays of the primary game by that player contribute to the increasing session score of sessions activated by that player. In another embodiment, one or more sessions are multi-player sessions, wherein more than one player's plays of a primary game contribute to the increasing session score. For example, if a group of friends decides to initiate a group session, the gaming system tracks a plurality of plays of the primary game played by the plurality of players and provide an appropriate session award when the session is complete. In one embodiment, a session is provided to each player at a single table, such as a single blackjack table, thus increasing the excitement and enjoyment generated by playing blackjack at a relatively crowded table of players. In one embodiment, wherein a promotional session is provided to one or more players without requiring a wager by the player(s), the promoter of the session determines which players can participate in the session. For example, if a corporate sponsor sponsors a promotional session, the gaming system may enable any employee of that corporation to participate in that session, and may cause an appropriate award to be provided to each corporate employee based on the eventual session score achieved.

In one embodiment, the gaming system enables a player to initiate a new session for one or more plays of the game regardless of whether other sessions are currently active. In a further embodiment, the gaming system enables the player to initiate a new session for each play of the primary game. In another embodiment, whether the gaming system enables the player to initiate a new session for a play of the primary game is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, wherein a player is participating in two or more simultaneous sessions (i.e., two or more session each span or include at least one same play of the primary game), whether a play of the primary game is optimal with respect to the two or more gaming sessions varies. In one such embodiment, the gaming system enables the player to simultaneously participate in a first gaming session and a second gaming session. In this embodiment, at least one play of the primary game contributes to both the first gaming session and the second gaming session. Moreover, in this embodiment, at least one decision potentially makeable by the player for the at least one play of the primary game represents an optimal play with respect to the first gaming session, and a sub-optimal play with respect to the second gaming session. In this embodiment, at least one decision potentially made by the player represents an optimal play with respect to both the first gaming session and the second gaming session, and at least one decision potentially made by the player represents a sub-optimal play with respect to the first gaming session and the second gaming session. In various embodiments, one or more decisions potentially makeable by a player is optimal or sub-optimal with respect to the plurality of gaming sessions as described above, and can also be either optimal or sub-optimal with respect to the play of the primary game for which the decision is made. It should be appreciated that at least one decision potentially made by a player can thus represent varying degrees of optimal decisions with respect to a plurality of simultaneously active gaming sessions. In one embodiment, the optimal or sub-optimal nature of the decisions makeable during the plays of the primary game with respect to a plurality of gaming sessions is determined based on one or more payout table associated with the gaming sessions, wherein different payout tables result in different decisions optimal and sub-optimal, depending on the payout table associated with the gaming session.

In one embodiment, the gaming system enables the player to simultaneously participate in a primary game and at least two gaming sessions, wherein the two gaming sessions are different types of games. In one embodiment wherein the primary game is a blackjack game, the gaming system enables the player to participate in a first gaming session which includes a session score that is incremented based on a plurality of plays of blackjack as discussed above. In this embodiment, the gaming system also enables the player to simultaneously participate in a second gaming session wherein the second gaming session determines a session award differently from the incrementing of a session score as discussed above. For example, the gaming system in one embodiment enables the player to participate in a second gaming session wherein the second gaming session generates a plurality of poker hands based on the cards dealt to the player in the plays of the primary blackjack game. In one such embodiment, at the end of the second gaming session (e.g., after a designated number of cards have been dealt sufficient to form a poker hand), the gaming system determines and provides a session award for the second session based on a comparison of the cards in the poker hand to a payout table similar to a table utilized in video poker. Thus, it should be appreciated that a single play of a primary game can simultaneously contribute to session awards for a plurality of different gaming sessions, wherein the session awards are determined based on different aggregations of a plurality of outcomes of a plurality of primary games.

Table 2, illustrated below, indicates the various combinations of decisions which can be made with respect to a gaming system providing a primary game and two simultaneous gaming sessions. In the illustrated embodiment, a decision which is optimal for the first gaming session can be sub-optimal for the second gaming session, and vice versa.

TABLE 2

| | Primary | First Gaming | Second Gaming |
|---|---|---|---|
| | Game | Session | Session |
| Decision 1 | Optimal | Optimal | Optimal |
| Decision 2 | Optimal | Optimal | Sub-Optimal |
| Decision 3 | Optimal | Sub-optimal | Optimal |
| Decision 4 | Optimal | Sub-optimal | Sub-Optimal |
| Decision 5 | Sub-optimal | Optimal | Optimal |
| Decision 6 | Sub-optimal | Optimal | Sub-Optimal |
| Decision 7 | Sub-optimal | Sub-optimal | Optimal |
| Decision 8 | Sub-optimal | Sub-optimal | Sub-Optimal |

In another embodiment, the gaming system enables a plurality of plays of a plurality of different types of primary games to contribute to a same gaming session. In this embodiment, a play of a primary poker game and a play of a primary blackjack game can both contribute to a session score of a same gaming session. In one embodiment, the gaming system determines an amount of contribution to a session score based on an average expected payback percentage of a particular type of primary game. For example, if an average expected payback for a play of a blackjack game is 99.2%, and an average expected payback to the plurality of players of a play of a poker game is 96% (i.e., the entire pot or pool is returned to one of the players, minus a rake of 4% of the pot or pool kept by the gaming establishment), the gaming system may cause a play of the poker game to contribute more heavily to a gaming session score than a play of the blackjack game. In another embodiment, a play of each type of primary game contributes to a session score equally, regardless of the type of primary game. In various embodiments, the amount of contribution of a play of each of a plurality of different types of primary game is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria. It should be appreciated that in the embodiment described, the plurality of combinations of decisions indicated in Table 2 are equally applicable; that is, the decisions illustrated in Table 2 are not dependent upon the gaming sessions being conducted in the same way for each session.

In one embodiment, each session is a standard session length, such that each session spans a same number of plays of a primary game. For example, in one embodiment each session available to the players of the disclosed gaming system spans ten hands of blackjack. In another embodiment, the session length of one or more sessions is not equal to a standard session length based on a number of plays of the primary game. In one embodiment, a session length is determined based on a number of plays of the primary game which occur during a designated amount of time. For example, in one embodiment a session spans any number of plays of a primary game which occur within a twenty minute session timeframe. In various embodiments, the session length of one or more sessions is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system disclosed herein is configured to utilize or apply different payout tables depending on the number of plays of a game of a session. For example, the gaming system determines whether to provide a session award based on a first payout table if the session spans ten plays of the primary game, and based on a second payout table if the session spans twenty plays of the primary game.

In various embodiments, the different payout tables include different numbers of tiers and/or require different average total card values per hand depending on the length of the session. For example, if a session is relatively short, a payout table in one embodiment requires a relatively high total card value per hand to provide a session award. If, on the other hand, a session is relatively long, a payout table in one embodiment requires a relatively lower total card value per hand average to provide a session award.

In general, the longer a gaming session, the larger the largest possible gaming session award. For example, in one embodiment, a gaming session spanning ten plays of a primary game has a substantially smaller maximum award than a gaming session spanning one-hundred plays of the same primary game. In one embodiment, the gaming system also enables players to participate in a mini-session, wherein the mini-session spans a relatively small quantity of plays of the primary game, such as five plays of the primary game. In this embodiment, the maximum winnable session award for a mini-session is smaller than the maximum winnable session award for a standard gaming session.

In one embodiment, the gaming system provides players an opportunity to win a progressive award based on a session outcome of a gaming session spanning an appropriate number of plays of a primary game. For example, in one embodiment, a portion of each wager on a gaming session (or a portion of each wager on a play of the primary game) is used to fund a progressive award. For a session spanning a sufficiently large number of plays of the primary game, a session score above a certain progressive threshold results in a player winning the progressive award, whatever its current value. In one embodiment, the session score threshold for winning the progressive award is dependent upon the length of the session. In other embodiments, the session score threshold for winning the progressive award is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system disclosed herein provides gaming sessions and payout tables which are overlapping, such that for a play of a primary game, session scores of at least two different gaming sessions are incremented. For example, in one embodiment the gaming system enables a player to participate in a gaming session spanning one-hundred plays of a primary game (the “long session”); and allows a player to simultaneously participate in ten gaming sessions serially spanning sets of ten plays of the primary game (the “short sessions”). Thus, the outcomes of first through the tenth play of the primary game result in the gaming system incrementing the session scores of the first short session and the long session, the outcomes of the eleventh through the twentieth play of the primary game result in the gaming system incrementing the session scores of the second short session and the long session, and so on. In one embodiment, the gaming system applies different payout tables for determining the session awards of the long session and the short sessions, wherein the largest possible session award for the long session is substantially larger than the largest possible session award for any of the short sessions.

In various embodiments, gaming sessions span varying quantities of plays of a primary game. In one embodiment, the gaming system provides any session awards to the players based on a tiered payout table, such as the tiered payout table illustrated in FIG. 6. In another embodiment, the gaming system maintains a plurality of payout tables, such as the payout table of FIG. 6, wherein each payout table includes at least one different tier from at least one other payout table. In this embodiment, the gaming system determines which payout table to apply in real-time, during a play of the game. In various embodiments, which payout table to apply is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system enables a player to discard or ignore the outcome of one or more plays of a primary game of a gaming session. For example, the gaming system enables the player to elect that one out of every eleven plays of a primary game can be discarded, such that the primary game outcomes of the remaining ten plays of the primary game contribute to the session score. In one embodiment, the gaming system requires the player to elect which play of the primary game to discard at the time of that play of the primary game. In another embodiment, the gaming system automatically discards the play of the primary game with the lowest contribution to the session score at the conclusion of a gaming session. In one embodiment, the gaming system enables a player to discard one or more plays of the primary game for free. In another embodiment, the gaming system enables the player to discard one or more plays of the primary game in exchange for an additional wager. In one embodiment, the gaming establishment provides promotional materials such as coupons to potential players which enable the player to elect to discard a play of the primary game during a gaming session. In other embodiments, the gaming system enables a player to discard one or more plays of a primary game for reasons which are predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the players primary game wager, determined based on time (such as the time of day), determined based on an amount of coin-in accumulated in one or more pools or determined based on any other suitable method or criteria.

In one embodiment, the gaming system alters which payout table is applied based on the current session score of the gaming session. For example, the gaming system applies a payout table associated with higher awards if a player satisfies a session score threshold at a designated point in time during the session, such as halfway through the session. In one embodiment, the gaming system enables the player to alter the payout table being applied to one or more active sessions by providing an additional wager on one or more active gaming sessions. In various embodiments, whether the payout table is altered during any gaming session is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system disclosed herein enables a player to place a side wager during the course of a gaming session which causes the gaming system to utilize a more favorable payout table in determining any session awards at the conclusion of the gaming session. For example, if a player believes that for the remainder of the session, it will be difficult or unlikely to win a session award, the player can elect to place an additional or side wager, and in exchange the gaming system utilizes a payout table having lower thresholds for winning session awards. In this example embodiment, the gaming system does not reset the session score, and does not alter the number of plays of the primary game remaining in the session. In one embodiment, the side wager discussed above can be made regardless of whether the player initially wagered on the gaming session or whether the gaming system enabled the player to participate in the gaming session without providing any wager on the gaming session. In one embodiment, the newly applied payout table enables the player to win a session award having a value in excess of the side wager, but below the initial wager on the gaming session (if any). In another embodiment, the newly applied payout table enables the player to win a session award having a value which exceeds the sum of the initial wager on the gaming session (if any) and the side wager on the newly applied payout table.

In one embodiment, the gaming system disclosed herein is configured to increment the session score regardless of whether a player of a hand of the primary blackjack game wins or loses that hand. For example, if a player receives cards with a total value of eighteen, the gaming system in one embodiment increments any appropriate session scores for that player whether the dealer received cards with a total value of twenty (i.e., the player lost), the dealer received cards with a total value of seventeen (i.e., the player won), or the dealer received cards with a total value exceeding twenty-one (i.e., the dealer busted and the player won). In another embodiment, the gaming system disclosed herein increments the session score based on total card values of winning hands of blackjack. For example, if a player receives cards with a total value of eighteen, but the dealer receives cards with a total value of nineteen, the gaming system in one embodiment does not increment the session score. On the other hand, if the player receives cards with a total value of eighteen and the dealer receives cards with a total value of seventeen (or if the dealer busts), the gaming system in this embodiment increments the session score by eighteen.

In one embodiment, the gaming system disclosed herein does not increment any session scores for a player if that player busts during a hand of blackjack. For example, the gaming system does not increment the player's session score(s) if the player receives cards with a total value exceeding twenty-one. In another embodiment, the gaming system increments the player's session score(s) by a consolation amount, such as by five points, if the player busts during a play of the game. In various embodiments, the consolation amount is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, for a play of a blackjack primary game, the gaming system counts the play of blackjack as a single one of the plurality of plays spanned by a gaming session, regardless of the outcome of the play of blackjack. Thus, if a player splits a hand of blackjack (resulting in two separate hands and two separate wagers), the gaming system increments the session score based on one or both of the resulting hands, but only counts the split hand of blackjack as a single play for purposes of the length of the gaming session. For example, the gaming system may increment the session score based on the best hand of any hands resulting from a split during a play of blackjack. In an alternative embodiment, the gaming system increments the session score based on the outcome of the first hand resulting from a split, or based on the outcome of each of the hands resulting from a split during a play of blackjack, while still only counting the split hands as a single play of the primary game. In various embodiments, which of the hands is utilized for incrementing the session score is determined based on a player's selection of one of the hands, predetermined, randomly determined; determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In other embodiments, the gaming system disclosed herein is configured to determine a session length based on a quantity different from a quantity of plays of a game. In one such embodiment, a single play of a game can span a plurality of discrete events for purposes of determining whether a session has ended. For example, in a blackjack embodiment, the gaming system increments the session score based on each hand resulting from a split in a play of blackjack, and counts the play of blackjack as multiple hands for purposes of determining the length of any active gaming sessions. That is, if a player playing blackjack splits the same hand two times, the gaming system determines that three hands have occurred for purposes of determining the length of an active session. In this embodiment, the length of the session is determined based on the number of times the session score is incremented, as opposed to the number of hands or plays of blackjack that occur. In another blackjack embodiment, the score accumulated by a dealer hand or by the hand of another player increments a session score, and the number of times the session score is incremented for a single hand can exceed one (i.e., the session score is incremented for each player hand and the dealer hand). Thus, a gaming session spanning ten increments of the session score could span five plays of blackjack if a single player's cards and the dealer's cards increment the session score for each of the plays of blackjack. In another example embodiment, wherein a gaming session spans a plurality of plays of baccarat, the gaming system only increments the session score when a player or banker receives three cards. Thus, if a player and a banker both receive only two cards for a play of baccarat, the gaming system does not increment the session score at all, and the session is not any closer to being over. On the other hand, if either the player or the banker (but not both) receive three cards for a play of baccarat, the gaming system increments the session score only once, based on whichever hand received three cards. Thus, the session is one hand closer to being over. If both the player and the dealer receive three cards for a play of baccarat, the gaming system increments the session score twice and the gaming session is two hands closer to being over. Thus, it should be appreciated that depending on the rules for incrementing a gaming session, the gaming session may be incremented more than once for a single play of the primary game.

In one embodiment, as discussed above, the gaming system determines a session award based on a session score at the termination or end of a session. For example, the gaming system determines whether to provide any session award after the tenth blackjack hand of a ten hand session. In another embodiment, the gaming system determines whether to provide a session award based on a session score accumulated at a different point during the session. For example, the gaming system determines whether to provide any session award after the fifth hand of a ten hand session. In various embodiments, the point of the gaming session at which the gaming system determines whether to provide a session score is predetermined, randomly determined, determined based on the players status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system disclosed herein enables a player to elect to terminate one or more sessions prior to the end of such sessions. For example, if the player determines (and/or the gaming system displays to the player) that it is impossible to achieve a session award based on the session score achieved through five hands of a ten hand blackjack session, the gaming system enables the player to terminate the currently active gaming session. In one embodiment, the gaming system enables the player to terminate the gaming session without providing any award to the player. In another embodiment, the gaming system provides the player with a consolation upon early termination of a session. In one such embodiment, the consolation award is based on any side wager placed to begin the session, such as a percentage of any side wager. In various embodiments, whether and/or when the gaming system enables the player to terminate a currently active gaming session is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system enables the player to elect, part way through a gaming session spanning a plurality of plays of a primary game, to receive a partial award in exchange for ending the gaming session early. In one such embodiment, wherein the player wagered on the gaming session to activate the gaming session, the partial award can be viewed as a partial refund of the player's wager. In one embodiment, the gaming system only enables the player to elect to receive such a partial award if it would be possible for the player to receive an award at the end of the gaming session. In this embodiment, if, given the number of plays of the primary game remaining and the additional session score needed to reach a bottom or lowest tier of a payout table, the player cannot possibly win a session award, the gaming system does not enable the player to elect to receive a partial session award for the gaming session.

In one embodiment, the gaming system enables a player to elect to increment the session score for one or more sessions based, in part, on at least one dealer outcome of a primary game. For example, in a blackjack game, the gaming system enables the player to elect to increment the session score based on the total value of the cards in the dealer's hand. In this embodiment, the gaming system counts a single distribution of cards to one player and one dealer as two hands for purposes of determining whether an active session has expired. In one embodiment, the gaming system does not increment the session score if the dealer busts, but still counts the dealer's hand as one of the hands of blackjack spanned by the session. In various embodiments, whether the gaming system increments the session score based on the outcome of the dealer's hand is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system disclosed herein enables a player to wager on a dealer gaming session. In this embodiment, in exchange for an appropriate wager on the dealer gaming session, the gaming system tracks the session score based on a plurality of plays of a primary game played by the dealer, such as ten plays of blackjack. In one embodiment, a payout table applicable to the dealer session is utilized to determine an award at the conclusion of the dealer session. In one embodiment, a plurality of players at a same gaming table can wager on a same dealer session, such that the dealer session score is applicable to determine a communal or community session award at the conclusion of the dealer gaming session. In one embodiment, the dealer session increases player excitement and enjoyment by enabling the player to maker a defensive wager, wherein even if the player is unsuccessful over a plurality of plays of a primary game (i.e., if the dealer wins many of the plays of blackjack of a ten play gaming session), the player is eligible to win a session award based on the dealer's good luck. Moreover, in one embodiment the dealer can manually track a single dealer session score throughout a dealer gaming session, such that the dealer session wager option can be implemented in a table without the tracking capabilities discussed above. It should be appreciated that in one embodiment, the dealer session is determined based on actions taken by the dealer, wherein the actions of the dealer are not discretionary. That is, in one embodiment of a blackjack game, a set of rules requires a dealer to hit until the dealer has a total value of cards exceeding sixteen. In this embodiment, player strategy and skill do not impact the dealer session score. In another embodiment, the dealer gaming session option increases player excitement and enjoyment because players who feel the dealer is on a “hot streak” can attempt to mitigate perceived future losses by wagering that the dealer's “hot streak” will continue. Moreover, players who feel that they have an idea of what a next card will be can elect to hit or not to hit based, in part, on the impact the perceived next card will have on the dealer's session score. As noted above, in an embodiment wherein a gaming session spans a plurality of plays of a primary game by a dealer (i.e., where no decisions are made as to strategy in the primary game), a side wager on the gaming session may be required to participate in that gaming session.

In one embodiment, the gaming system disclosed herein increments an active session score based on fewer than all of the gaming elements displayed for a play of the primary game. In one blackjack embodiment, the gaming system increments the session score based on fewer than all of the cards in a player's hand. For example, the gaming system increments the session score for one or more hands based on the initial two cards dealt to the player (i.e., based on the cards dealt prior to any hitting, splitting, or other alteration of the player's hand). In one embodiment, the gaming system increments the session score based on the first two cards of any hand created based on splitting. For example, if a player is dealt two eights and elects to split the hand, the gaming system increments the session score based on the first card added to each new hand (i.e., based on the eight and the first additional card). It should be appreciated that in this embodiment, the gaming system enables the player to increment the session score by more than twenty-one points for a single hand of blackjack. For example, if the player splits two eights and receives a ten on each of the new hands, the gaming system increments the session score by thirty-six points.

In one embodiment, the disclosed gaming system enables a player to option a session win against certain losses sustained during play of the primary game. For example, the gaming system enables the player to make a wager wherein if the player wins the session award (i.e., if the player's session score is within an appropriate tier of the payout table), the gaming system returns some or all of the amounts wagered on the plays of the primary game during that session to the player.

In one embodiment, the gaming system awards the player a particular primary game element, such as a card or a face of a die, needed to win a session award, despite the primary game element not being applied to the play of the primary game. For example, if a player needs a certain card during a blackjack game to win a session award, the gaming system applies that card to the session score and provides the appropriate session award to the player. In another embodiment, if a player is awarded a session award based on a session score, the gaming system enables the player to apply the session win to a play of a primary game to achieve a more favorable primary game outcome. For example, in a blackjack game, if a player receives a hand having a total value of seventeen, and the dealer has a hand with a total value of nineteen, the gaming system enables the player to apply a session award in the form of an additional card with a value of three such that the player wins the play of the primary game. In various embodiments, whether the gaming system enables the player to apply a primary game win to the session game, or a session game win to the primary game, is predetermined, randomly determined, determined based on the player's status (such as determined through, a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, if the player has achieved a designated session score, the gaming system enables the player to apply that session score to the primary or base game so as to automatically win at least one play of the primary or base game. For example, in a blackjack embodiment, if the player has achieved a sufficiently high session score, the gaming system enables the player to apply that session score to a hand of blackjack such that the player automatically beats the dealer for that hand. In various embodiments, whether the session score results in such an option is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system increments the session score of a current session based on an amount unrelated to the current session and any plays of the primary game of the current session. In one embodiment, the gaming system increments the session score of a current session score based on a session score achieved during a prior session. For example, the gaming system increments the session score of a current session by an average session score increment amount of each of the plays of the primary game of a previous game. That is, for a first set of ten plays of a primary game, the gaming system determines an average contribution to a session score. For each of the next ten plays of the primary game (which constitute a current session), the gaming system applies the average score from the prior ten plays of the primary game to the session score of the current session. In other embodiments, the gaming system increments a session score of a current session based on an amount which is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, certain game outcomes of the primary game result in an additional increase in the session score. In a blackjack embodiment, if a player receives a designated combination of cards during a hand of blackjack, the gaming system applies an additional bonus score to the session score. For example, if a player is dealt a blackjack during a play of the primary blackjack game, the gaming system in one embodiment increments the session score by twenty-five points. In one embodiment, if a player hits to a hand having a total value of twenty-one during a play of a primary blackjack game, the gaming system provides a bonus award, such as an award of twenty-five points. In one embodiment, if a player busts during a play of blackjack, the player receives a minimum score, such as six points, which is added to the session score. In one embodiment, if a play of a primary game results in an immediate loss prior to the player being able to make any decisions for that play of the game (e.g., if the dealer is dealt a blackjack), the gaming system increments the session score by a minimum amount, such as by twelve points. In one embodiment, if a player elects to purchase insurance, the player is guaranteed at least a minimum increase in his or her session score, such that if the player purchases insurance and the dealer does have blackjack, the player still receives some increment to the session score. In one embodiment, the gaming system increments the player's session score based on a total value of a plurality of cards of the player's hand prior to receiving a bust card. In this embodiment, it should be appreciated that the gaming system encourages a player to hit despite a relatively high probability of busting (e.g., by providing zero or relatively few points of the session score).

In one embodiment, rather than incrementing a session score, the gaming system disclosed herein decrements a session score based on a plurality of plays of a primary game. In this embodiment, the gaming system utilizes a payout table which includes session score thresholds wherein the lower a session score at the end of a session, the higher the award provided to the player.

In one embodiment, the gaming system combines the results of one or more sessions into a single combination session result. In one embodiment, a combination session result potentially results in a higher session award than a standard session award provided for a standard gaming session. In various embodiments, which session results can be combined into the combination session result are predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system enables players to participate in one or more super sessions by providing players with player accounts to track session activity. In this embodiment, any session activity detected by the gaming system (e.g., any results of hands of blackjack detected by the intelligent table disclosed herein) are stored in an appropriate player tracking system in association with a record corresponding to a particular player. Moreover, the player's progress through a super session is tracked and an indication of such progress is stored, such that a player can play a portion of a super session, temporarily cease wagering on plays of a primary game (e.g., at the end of a day of gaming), and resume the previously activated super session based on data stored in the player's account. Thus, particularly when sessions span a relatively large number of plays of a primary game (e.g., one-hundred plays of a primary blackjack game), the gaming system enables the player to complete the session over the course of multiple days, rather than requiring the player to complete the session in a single sitting.

In one embodiment, a session spans a plurality of non-consecutive plays of a primary game. For example, in one embodiment the gaming system maintains an account for a player, and tracks the player's primary game activity regardless of whether the activity is associated with a session. In this embodiment, the gaming system enables the player to utilize non-consecutive plays of the primary game, such as plays of the primary game to form a session score and to potentially win a session award. For example, in one embodiment, the gaming system applies only the first hand of a new shoe of cards in a primary blackjack game. In another embodiment, the gaming system only applies any hand of a primary blackjack game which occurs after the first half of the shoe has been dealt. In various other embodiments, which non-consecutive plays of the primary game are applied to the session score is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, the gaming system disclosed herein enables players to participate in a tournament session. In this embodiment, the gaming system enables one or more players to join a tournament session wherein a relatively small number of relatively large prizes are available at the end of the tournament. In one such embodiment, the tournament session award is a progressive award, wherein the value of the award depends on the amount of gaming activity in the tournament. In various embodiments, a tournament session spans a plurality of gaming tables, a plurality of gaming establishments, or even a plurality of gaming periods of time. In an example embodiment, a tournament session enables a player to obtain a tournament session score for one-hundred plays of a primary game, and compares that player's tournament session score to the tournament session score of all other players. The gaming system in one embodiment enables the player to complete his or her hundred plays of the primary game at any time during a designated tournament period, such as during a designated tournament week. In one embodiment, the tournament session is a recurring tournament session, such that each week, the player with the highest session score is awarded a recurring tournament award.

In one embodiment, the gaming system enables a player to participate in a tournament wherein the score for purposes of determining awards in the tournament is based on a tournament session score. In one such embodiment, the gaming system enables the player to accumulate as many total session points as possible over a designated period of time. For example, the gaming system enables the player to accumulate as many points as possible over the course of a tournament session spanning an hour, a day, a weekend, a week, a month, a year, or any other appropriate period of time. In one embodiment, at the conclusion of the time period, the gaming system compares the player's tournament session score with the tournament session scores of other players, and provides awards based on that comparison. In another embodiment, the gaming system additionally constrains the maximum number of plays of a game which can contribute to a tournament session score during the course of time of the tournament session. For example, the gaming system enables the player to participate in a tournament session which can span as long as one week, but the gaming system stops incrementing the tournament session score after the player has played one-thousand hands in that week. It should be appreciated that in various embodiments, the gaming system enables a player to potentially win an award for a session spanning a relatively long period of time (e.g., a week or a month), even if the player does not win many session awards for standard sessions contained in the tournament session. That is, if a player consistently achieves session scores just below the lowest threshold for providing a standard session award, the aggregate score (i.e., tournament session score) may be high enough to result in a tournament session tournament win, based on the consistency of the session scores over a long period of time.

In one embodiment, the gaming system disclosed herein provides a player an award for a tournament session regardless of the player's level of play. That is, the gaming system provides the player with an award regardless of an average wager amount over the course of a gaming session. In this embodiment, therefore, the gaming system provides the same award to a player making relatively large wagers as to a player making relatively smaller wagers. In another embodiment, the gaming system modifies the award provided to a player based on the player's average wager amount for the plurality of plays of the game which make up the tournament session. In one such embodiment, the gaming system applies a multiplier to a base award depending on the average amount of a player's wagers over the course of the tournament session. For example, if a base tournament session award is one-thousand credits, and the minimum wager amount for a play of the game is five credits, the gaming system divides a player's average wager amount for the tournament session by five credits and multiplies the one-thousand credit award by the result. Thus, if a player wagers, on average, twenty-five credits on plays of the game making up the tournament session, the gaming system multiplies the one-thousand credit award by five and provides the player an award of five-thousand credits. In another embodiment, different awards are associated with different ranges of wager levels. For example, if a first player wagers, on average, five credits per play of the game, and a second player wagers, on average, twenty-five credits per play of the game, the gaming system enables the first player to potentially win a first award associated with the first player's wager level and enables the second player to potentially wing a second award associated with the second player's wager level. In one embodiment, the gaming system enables different players to win different tournament session awards depending on the players' average wager amounts per play of the game, but provides each of the players with an equal chance of winning those different awards. Thus, a first player playing at a relatively lower level than a second player has the same chance of winning an award for the tournament session as the second player, but the award potentially winnable by the first player is smaller in magnitude than the award potentially winnable by the second player.

In one embodiment, the gaming system disclosed herein only needs to be configured to track game play of a standard game. For example, the gaming system may only be required to track the cards dealt to the player(s), the cards dealt to the dealer, and any wagers made by the player. Thus, in one embodiment, the gaming system disclosed herein enables a standard casino gaming table, such as a standard blackjack table, to be retrofitted with the appropriate hardware needed to so track the cards and chips of a blackjack game. In a further embodiment, because the disclosed game does not alter the underlying rules of the primary game, the gaming system disclosed herein enables players to play the sessions game without learning additional rules or variations of rules to standard games.

In another embodiment, the gaming system disclosed herein is initially provided with the appropriate hardware capabilities to track chips, cards, and/or player activity as discussed above. For example, in one embodiment, the gaming system disclosed herein implements the disclosed session gaming using a suitable table game tracking system, such as the Table iD® system by IGT. Table iD® is a registered trademark of IGT.

In one embodiment, a player is required to insert a player tracking card, key in a player tracking identification code, or otherwise indicate to the gaming system that the player is playing the primary game. In this embodiment, one or more sessions may span one or more visits to a gaming establishments, play of the primary game at one or more tables, or any other suitable pattern of gaming for a player. In various embodiments, the player indicates his or her gaming activity to the gaming system by indicating that gaming activity using a suitable player tracking system, as is well known in the art.

In one embodiment, at least one session is initiated by a player of the gaming system disclosed herein. In another embodiment, the gaming session is initiated by a representative of the gaming establishment, such as a dealer or other appropriate gaming establishment employee. In various embodiments, the individual or entity which initiates a session is predetermined, randomly determined, determined based on the player's status (such as determined through a player tracking system), determined based on a generated symbol or symbol combination, determined based on a random determination by the central controller, determined based on a random determination at the gaming system, determined based on one or more side wagers placed, determined based on the player's primary game wager, determined based on time (such as the time of day), determined based on an amount of coin-in accumulated in one or more pools or determined based on any other suitable method or criteria.

In one embodiment, wherein the gaming system includes at least one server, the disclosed system enables one or more messages or offers about session gaming opportunities to be transmitted to a player while the player is engaged in a gaming session. For example, the gaming system displays a message to a player indicating a particular promotional session using a display device such as the display devices 320 of FIG. 9A, 9B, 9C, 9D, or 9E.

In another embodiment, each gaming device (or player tracking account) in the gaming system is associated with or otherwise maintains a separate pool or meter, wherein each pool is individually funded as a percentage of the total or partial amounts wagered at that individual gaming device. In one embodiment, each gaming device includes a separate coin-in or wager meter which tracks the total or partial coin-in or wagers placed on the primary games played at that gaming device. In another embodiment, as mentioned above, the central controller includes a separate coin-in or wager meter for each individual gaming machine which tracks the total or partial coin-in or wagers placed on the primary games for each of the gaming machines in the gaming system, wherein the central controller maintains an individual pool for each gaming machine in the gaming system. In another embodiment, the central controller maintains a separate pool or meter for each player which is tracked via a player tracking system (implemented through the use of a playing tracking card or any other suitable manner or suitable system). In this embodiment, if a player leaves a gaming machine of the gaming system, that player's wagered amounts and pool are saved for the player (via the player tracking system, the player tracking card or any other suitable system) for later use at another gaming machine.

It should be appreciated that, for ease of illustration and discussion, the instant disclosure focuses primarily on a gaming system which tracks a plurality of plays of a standard blackjack game played using physical gaming elements, such as physical cards and physical casino chips. In another embodiment, the gaming system disclosed herein is configured to provide a virtual representation of a primary game, such as by displaying blackjack gaming elements on an appropriate display device and enabling the player to interact with the gaming system using an appropriate input device. In other embodiments, the disclosed gaming system is configured to track and/or provide a virtual representation of a primary game which is a different type of game, such as a Baccarat game, a Sic Bo game, a craps game, a poker game, a roulette game, or any other suitable standard or non-standard game.

Specifically, it should be appreciated that the disclosed gaming system is particularly well-suited to provide one or more gaming sessions spanning a plurality of plays of a primary game wherein each play of the primary game is quantifiable based on a number of points achieved in the primary game. Thus, in a Baccarat primary game, the ones digit of the sum of the cards in the hand of either the banker or the player is usable to increment a session score. Similarly, in a dice-based game, the sum of the thrown dice is usable to increment a session score. For example, in a Sic Bo game or a craps game, the gaming system may increment a session score based on a total number of spots shown for ten consecutive rolls of the dice. Alternatively, the gaming system may increment as session score based on a total number of spots shown for ten rolls of the dice following the setting of a point in a craps game.

In another embodiment, the gaming system and methods disclosed herein enable a player to participate in one or more gaming sessions by utilizing a Class II bingo game. In one such embodiment, the gaming system determines the outcomes of each of the plurality of plays of the primary game based on one or more outcomes of one or more bingo games. In another embodiment, the outcome of one or more gaming sessions is determined based on the outcome of one or more bingo games, and each primary game outcome corresponds to a subset or sub-outcome of such a bingo game.

One of ordinary skill in the art will understand that the concepts discussed above with respect to the blackjack embodiment are adaptable to any suitable quantifiable primary game.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A gaming system comprising:
at least one display device;
at least one input device;
at least one processor; and
at least one memory device which stores a plurality of instructions, which when executed by the at least one processor, cause the at least one processor to operate with the at least one display device and the at least one input device to:
(a) enable a player to wager on a plurality of plays of a primary game, each play of the primary game including a game outcome selected from at least three different primary game outcomes;
(b) for each of the plurality of plays of the primary game:
(i) enable the player to provide at least one input in association with said play of the primary game, wherein said at least one player input at least in part determines the selected primary game outcome from the at least three different primary game outcomes for said play of the primary game,
(ii) alter a session score of a gaming session including the plurality of plays of the primary game based on said selected primary game outcome for said play of the primary game, and
(iii) provide any primary game award for said play of the primary game based on the selected primary game outcome of said play of the primary game; and
(c) thereafter, determine and display any session award based on the session score.

2. The gaming system of claim 1, wherein, when executed by the at least one processor, the instructions cause the at least one processor to enable the player to make the at least one input in association with each play of the primary game by providing an input, for each play of the primary game, which is one selected from the group consisting of:
(a) an optimal input with respect to that play of the primary game and a sub-optimal input with respect to the session score,
(b) a sub-optimal input with respect to that play of the primary game and an optimal input with respect to the session score, and
(c) a sub-optimal input with respect to that play of the primary game and a sub-optimal input with respect to the session score.

3. The gaming system of claim 1, wherein the primary game is one selected from the group consisting of: a blackjack game, a craps game, a Sic Bo game, a poker game, and a Baccarat game.

4. The gaming system of claim 1, wherein, when executed by the at least one processor, the instructions cause the at least one processor to enable the player to provide at least one input in association with each play of the primary game by manipulating physical objects selected from the group consisting of: one or more dice and one or more cards.

5. The gaming system of claim 4, which includes at least one physical object tracking device, and wherein, when executed by the at least one processor, the instructions cause the at least one processor to operate with the at least one physical object tracking device to determine the selected primary game outcome for each play of the primary game based on the manipulated physical objects.

6. The gaming system of claim 1, which includes a gaming table and at least one physical gaming element tracking device, and wherein the instructions, when executed by the at least one processor, cause the at least one processor to operate with the at least one physical gaming element tracking device to track a plurality of physical gaming elements and alter the session score based, in part, on the tracked physical gaming elements.

7. A session gaming apparatus configured to operate with a gaming table and a plurality of physical gaming elements, said session gaming apparatus comprising:
at least one gaming session processor;
at least one display device;
at least one physical gaming element tracking device, said at least one physical gaming element tracking device configured to determine data indicative of a manipulation of the plurality of physical gaming elements during at least one play of a primary game at the gaming table; and
at least one memory device which stores a plurality of instructions, which when executed by the at least one processor, cause the at least one processor to operate with the at least one display device and the at least one physical gaming element tracking device to:
(a) determine a primary game outcome for each of a plurality of plays of a primary game at the gaming table, each primary game outcome based on the data indicative of the manipulation of the plurality of physical gaming elements,
(b) alter a gaming session score for a gaming session based on the data indicative of the manipulation of the plurality of physical gaming elements each of the plurality of plays of the primary game at the gaming table, the gaming session including the plurality of plays of the primary game, and
(c) after the plurality of plays of the primary game at the gaming table:
(i) determine a session award for the gaming session based on the gaming session score and at least one payout table, and
(ii) display an indication of the determined session award.

8. A gaming system comprising:
at least one display device;
at least one input device;
at least one processor; and
at least one memory device which stores a plurality of instructions, which when executed by the at least one processor, cause the at least one processor to operate with the at least one display device and the at least one input device to:
(a) enable a player to participate in a gaming session, the gaming session including a plurality of plays of a primary game, each play of the primary game including a quantifiable outcome determined based on an initial primary game condition and a player input during the play of the primary game, the player input being either an optimal input or a sub-optimal input;
(b) for each play of the primary game, increment a gaming session score of the gaming session based on the quantifiable outcome of that play of the primary game, said quantifiable outcome being, on average, greater if the player input for that play of the game is the optimal input than if the player input for that play of the game is the sub-optimal input; and
(c) determine a session award of the gaming session based on a comparison of the gaming session score with at least one payout table, said payout table including a plurality of tiers, each tier including a range of gaming session scores and an associated session award.
